(19) United States
(12) Patent Application Publication
(10) Pub. No.: US 2003/0130798 A1
(43) Pub. Date: Jul. 10, 2003

(54) Multiparameter integration methods for the analysis of biological networks

(75) Inventors: Leroy E. Hood, Seattle, WA (US); Trey E. Ideker, Cambridge, MA (US)

Correspondence Address: CAMPBELL & FLORES LLP, 4370 LA JOLLA VILLAGE DRIVE, 7TH FLOOR, SAN DIEGO, CA, 92122, US

(73) Assignee: The Institute for Systems Biology

(21) Appl. No.: 09/993,312

(22) Filed: Nov. 13, 2001

Related U.S. Application Data
(60) Provisional application No. 60/248,257, filed on Nov. 14, 2000.
(60) Provisional application No. 60/266,038, filed on Feb. 2, 2001.

(51) Int. Cl. G06F 19/00

(52) U.S. Cl. 702/19

(57) ABSTRACT

The invention provides methods of predicting a behavior of a biochemical system. In one embodiment, the method consists of comparing two or more data integration maps of a biochemical system obtained under different conditions, the data integration map comprising at least two networks, and identifying correlative changes in at least two value sets between said two or more data integration maps with different conditions, wherein the correlative changes predict a behavior of the biochemical system.

This application claims the benefit of U.S. Provisional Application No. 60/248,257, filed Nov. 14, 2000, and U.S. Provisional Application No. 60/266,038, filed Feb. 2, 2001, which are incorporated herein by reference.

### BACKGROUND OF THE INVENTION

This invention relates generally to genome-wide analysis and, more specifically, to a method of predicting the behavior of a biochemical system.

The Human Genome Project, by cataloging the sequences of the estimated 100,000 human genes, provides a first step in understanding humans at the molecular level. However, with the completion of the sequencing phase of the project, many questions remain unanswered, including what roles most of these genes play in cells and how the genes work together to perform functions in cells. The answers to these questions will lead to important advances and developments in both research and medicine.

Exemplified by genome sequencing projects, discovery science enumerates all the genes or encoded products of a genome without concern for their functional characteristics and cellular roles. The Human Genome Project and other large scale sequencing projects have fueled technological advances in discovery science. Large-scale gene sequencing, gene expression analysis methods, such as DNA microarrays, and proteomics methods have facilitated the accumulation of an enormous amount of data describing the sequences and expression levels of virtually every gene in organisms such as, the bacterium Escherichia coli, the yeast Saccharomyces cerevisiae, the worm Caenorhabditis elegans, as well as more complex organisms such as humans. Volumes of sequence and expression data can be obtained from virtually any cell or organism. However, standing alone, these volumes of sequence and expression data are difficult to interpret and apply to accurately predicting cellular functions of genes and their products, their interplay within a cell, or their dynamics in response to change.

Over the past several years, researchers have attempted to understand and characterize functions of the many newly identified genes having unknown cellular roles by testing experimental hypotheses. Such hypothesis-driven research to determining the function of an uncharacterized gene, or its encoded product, typically involves formulating a working hypothesis based on empirical observations provided by sequence comparisons and experimental data. The working hypothesis is then tested experimentally to determine if a proposed function is correct. The process is revised and repeated until experimental results are consistent with the working hypothesis of the proposed cellular function. Such an approach is labor-intensive, time-consuming and constrained by available functional information.

One reason for the difficulties in determining functions of uncharacterized genes and their products using a hypothesis driven research approach is that the observations which form the foundation of the working hypothesis and the investigated genes are viewed in an isolated or static manner. These views can result from either a lack of available information or from practical consideration which preclude analysis of the dynamic interplay of the other numerous genes and molecules in the cell. Absent such knowledge or assessment of the various relationships, the reference point or context in which to interpret experimental results can be misconstrued, viewed too narrowly or, perhaps too broadly.

Thus, there exists a need for methods which assimilate biological information into integrated models that are predictive of the characteristics and behavior of a cellular biochemical system. The present invention satisfies this need and provides related advantages as well.

### SUMMARY OF THE INVENTION

The invention provides a method of predicting a behavior of a biochemical system. In one embodiment, the method consists of comparing two or more data integration maps of a biochemical system obtained under different conditions, the data integration map comprising at least two networks, and identifying correlative changes in at least two value sets between said two or more data integration maps with different conditions, wherein the correlative changes predict a behavior of the biochemical system.

In another embodiment, the method consists of obtaining a first data integration map of a biochemical system, the data integration map comprising value sets of two or more data elements for at least two networks, producing a second data integration map of the biochemical system under a perturbed condition, the second data integration map comprising the value sets of two or more data elements for the at least two networks, and identifying correlative changes in at least two value sets in the second data integration map with the perturbed condition, wherein the correlative changes predict a behavior of said biochemical system.

In a further embodiment, the method consists of obtaining a first physical interaction map of a biochemical system, the physical interaction map comprising value sets of a physical interaction data element and an expression data element for at least two independent networks, producing a second physical interaction map of the biochemical system under a perturbed condition, the second physical interaction map comprising the value sets of a physical interaction data element and an expression data element for at least two independent networks, and identifying correlative changes in at least two value sets in different independent networks in the second physical interaction map with the perturbed condition, wherein the correlative changes predict a behavior of said biochemical system.

Also provided are methods of identifying functionally interactive components of a biochemical system. The methods consist of obtaining a set of components within a biochemical system linked by physical interactions, obtaining a set of components within a biochemical system linked by expression or activity, and integrating the set of physically linked components with the set of components linked by expression or activity to produce a network of common components functionally interactive within the system, each component within the network of common components being characterized as having at least one physical interaction with a component within the set of components linked by expression or activity.

The invention provides a method of indentifying a component of a biochemical network. In one embodiment, the method consists of preparing a physical interaction map between two or more system components, identifying a system component exhibiting altered expression or activity in response to perturbation of a pathway component, and refining the physical interaction map to include a pathway component, an altered system component and an unaltered system component exhibiting at least one physical interaction with an altered system component, the refinement identifying at least one component of a biochemical interaction network by inclusion into the physical interaction map.

In another embodiment, the method consists of perturbing the expression or activity of at least one pathway component, measuring a response of one or more pathway components, determining physical interactions between one or more system components and said one or more pathway components to identify candidate network components, and determining a change in expression or activity of a candidate network component affected by the perturbation of at least one pathway component, wherein a candidate network component exhibiting a change in expression or activity is identified as a component of the biochemical network.

The invention also provides a method of screening for compounds that restore a perturbation state of a biochemical system. The method consists of obtaining a data integration map of a perturbed biochemical system, the data integration map comprising at least two networks, contacting a biochemical system exhibiting a perturbation state corresponding to a data integration map with a test compound, and producing a second data integration map of the biochemical system contacted with the test compound, a compound that restores perturbed states in at least two value sets of the data integration map to unperturbed states indicating that the compound has biochemical system restoring activity.

The invention further provides a method of diagnosing or prognosing a pathological condition. The method consists of comparing a data integration map of a biochemical system for an individual suspected of having a pathological condition to one or more data integration maps of a biochemical system produced from an individual exhibiting a known condition, the data integration maps comprising at least two networks, and identifying a data integration map representing the known condition that is substantially the same as the data integration map for the individual suspected of having a pathological condition, the identified data integration map indicating the presence or absence of a pathological condition.

### BRIEF DESCRIPTION OF THE DRAWINGS

FIG. 1 shows a model of galactose utilization in the yeast Saccharomyces cerevisiae.

FIG. 2 shows a perturbation matrix for GAL genes and clusters of genes.

FIG. 3 shows a comparison between Northern blots and DNA microarray measurements.

FIG. 4 shows a scatter plot of protein vs. mRNA expression ratio for wt+gal vs. wt−gal.

FIG. 5 shows a representation of the integration of gene-expression responses with physical interactions. FIG. 5a shows the effects of the gal4Δ+gal perturbation superimposed on the network. FIGS. 5b and 5c show galactose utilization and glycogen metabolism, respectively. FIG. 5d shows the effects of the wt+gal perturbation on the physical interaction network.

FIG. 6 shows a tree comparing gene expression changes resulting from different perturbations to the galactose-utilization pathway.

### DETAILED DESCRIPTION OF THE INVENTION

This invention is directed to methods of assimilating biochemical data into models and rules that predict the behavior of a biochemical system. The invention is also directed to methods of using such models and rules to predict the behavior of a biochemical system. The methods involve integrating data describing individual components of a biochemical system into an organized representation of both the intracomponent and the intercomponent data. The data can include any information describing relationships, functions, characteristics and traits of both the components and of the system as a whole. Such information can include, for example, expression levels, activities, rates and intermolecular interactions of system components, as well as characteristics of the entire system. Additionally, the information can be further cataloged with reference to one or more specified conditions.

The organized representation of intra- and intercomponent data, or data integration map, provides the information needed to predict a behavior of a biochemical system. A data integration map can be used to combine expression, interaction, activity, phenotypic and other data, for example, into an output that provides a cognizable representation of the interactions, interrelations and interdependencies between components of a biochemical system. A data integration map can therefore describe the state of a biochemical system under specific circumstances or the actions that result from changes in the circumstances. Moreover, a data integration map identifies and defines molecular relationships, functions, and phenotypes resulting therefrom for both the components and the system itself. The information organized into a data integration map can be used to predict a current or future behavior, or characteristic, of a biochemical system. As such, the methods of the invention which employ data integration maps have a wide range of diagnostic and therapeutic applications.

The term “behavior” when used in reference to a biochemical system is intended to mean a characteristic of the biochemical system under a specified condition. A characteristic of a biochemical system includes a characteristic of a component of the system or a global characteristic of the system. A characteristic of a component of the system includes a characteristic that can be represented by a data element, such as a physical interaction, expression level or activity that can be changed under a specified condition of a biochemical system. A global characteristic of a biochemical system includes a cellular phenotype, growth rate, differentiation state, or production of a metabolic product that can be changed under a specified condition of a biochemical system. A global characteristic of a biochemical system also can include, for example, groups, sets and categories of component characteristics of the system. One or more component or global characteristics can be used to describe the behavior of a biochemical system. A reference specified condition can be, for example, a dynamic or static condition and can be described relative to another specified condition.

As used herein, the term “biochemical system” is intended to mean a group of interacting, interrelated, or interdependent molecules that form a functional biochemical unit such as, for example, an organism, organ, tissue, cell or subcellular system. As used herein, the term “constituent system” refers to a biochemical system that is a subset of a biochemical system. A constituent system of an organism can be, for example, an organ, tissue or cell. Similarly, a constituent system of a cell can be a subcellular system such as, for example, an organelle or a cellular fraction, such as a nuclear, cytoplasmic or membrane fraction. A constituent system of a cell also can include subcellular systems such as an electron-transfer chain, a signal transduction cascade, a cytoskeleton, translation machinery, a secretory pathway, a nuclear pore complex, a nuclear scaffold, chromatin, transcriptional machinery and RNA processing machinery, DNA recombination machinery, and metabolic networks or pathways. A subcellular system can be contained in, for example, a cell, a cellular fraction or it can be substantially isolated. Groups of components which make up subcellular systems that form functional units are also included within the meaning of the term constituent system.

As used herein, the term “network” is intended to mean a group of interacting, interrelated, or interdependent molecules that consist of at least two biochemical pathways and function in common category of biochemical function. Therefore, a network is a higher order subcellular system made up of two or more constituent pathway systems that act together in order to effect one or more activities within a common functional category which characterizes the constituent pathways of the network. Acting together includes, for example, concerted functionally dependent relationships and interactions such as physical interactions, biosynthetic alterations, metabolic alterations or regulatory signals between at least one component molecule within two pathways. Such concerted actions can occur, for example, simultaneously or over time and can be proximal or distal in space compared to the reference molecule or pathway. Other types of interactions, interrelationships or interdependencies, also can occur and are well known to those skilled in the art. The number of concerted functionally dependent relationships and interactions can be small such as a single or a few common components or signals between two pathways of the network, or, the number can be large and include several to many interactive, interrelated or interdependent components between two or more pathways within a network.

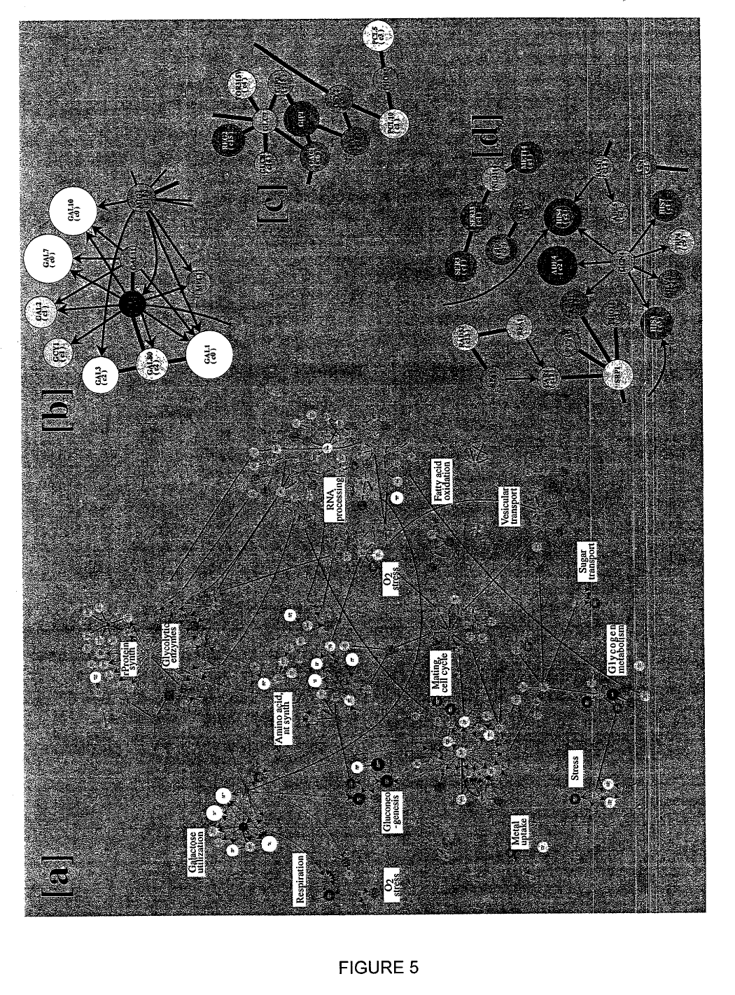

Specific examples of networks and network integration into a larger subcellular system is shown in FIG. 5. Therefore, a network also can contain one or more components that function in one or more categories of biochemical function in addition to functioning in the specific category of the network. A category of biochemical function refers to a type of cellular process, such as respiration, amino acid synthesis, protein synthesis, RNA synthesis, RNA processing, glycolysis, glycogen metabolism, morphogenesis, stress response, cell death, calcium uptake, mitochondrial function, organization of intracellular transport vesicles, and organization of cytoskeleton.

As used herein, the term “pathway” is intended to mean a set of system components involved in two or more sequential molecular interactions that result in the production of a product or activity. A pathway can produce a variety of products or activities that can include, for example, intermolecular interactions, changes in expression of a nucleic acid or polypeptide, the formation or dissociation of a complex between two or more molecules, accumulation or destruction of a metabolic product, activation or deactivation of an enzyme or binding activity. Thus, the term “pathway” includes a variety of pathway types, such as, for example, a biochemical pathway, a gene expression pathway and a regulatory pathway. Similarly, a pathway can include a combination of these exemplary pathway types.

A biochemical pathway can include, for example, enzymatic pathways that result in conversion of one compound to another, such as in metabolism, and signal transduction pathways that result in alterations of enzyme activity, polypeptide structure, and polypeptide functional activity. Specific examples of biochemical pathways include the pathway by which galactose is converted into glucose-6-phosphate and the pathway by which a photon of light received by the photoreceptor rhodopsin results in the production of cyclic AMP. Numerous other biochemical pathways exist and are well known to those skilled in the art.

A gene expression pathway can include, for example, molecules which induce, enhance or repress expression of a particular gene. A gene expression pathway can therefore include polypeptides that function as repressors and transcription factors that bind to specific DNA sequences in a promoter or other regulatory region of the one or more regulated genes. An example of a gene expression pathway is the induction of cell cycle gene expression in response to a growth stimulus.

A regulatory pathway can include, for example, a pathway that controls a cellular function under a specific condition. A regulatory pathway controls a cellular function by, for example, altering the activity of a system component or the activity of a biochemical, gene expression or other type of pathway. Alterations in activity include, for example, inducing a change in the expression, activity, or physical interactions of a pathway component under a specific condition. Specific examples of regulatory pathways include a pathway that activates a cellular function in response to an environmental stimulus of a biochemical system, such as the inhibition of cell differentiation in response to the presence of a cell growth signal and the activation of galactose import and catalysis in response to the presence of galactose and the absence of repressing sugars.

The term “component” when used in reference to a biochemical system, network or pathway is intended to mean a molecular constituent of the biochemical system, network or pathway, such as, for example, a polypeptide, nucleic acid, other macromolecule or other biological molecule.

As used herein, the term “polypeptide” when used in reference to a component of a biochemical system, is intended to mean two or more amino acids covalently bonded together. A polypeptide can be modified by naturally occurring modifications such as post-translational modifications, including phosphorylation, lipidation, prenylation, sulfation, hydroxylation, acetylation, addition of carbohydrate, addition of prosthetic groups or cofactors, formation of disulfide bonds, proteolysis, assembly into macromolecular complexes, and the like. A polypeptide can also contain minor modifications such as, for example, conservative substitutions of naturally and non-naturally occurring amino acids, amino acid analogs and functional mimetics. For example, Lysine (Lys) is considered to be a conservative substitution for the amino acid Arginine (Arg). Non-naturally occurring amino acids include, for example, (D)-amino acids, norleucine, norvaline, ethionine and the like. Amino acid analogs include modified forms of naturally and non-naturally occurring amino acids. Such modifications can include, for example, substitution or replacement of chemical groups and moieties on the amino acid or by derivitization of the amino acid. Amino acid mimetics include, for example, organic structures which exhibit functionally similar properties such as charge and charge spacing characteristic of the reference amino acid. Those skilled in the art know or can determine what structures constitute functionally equivalent amino acid analogs and amino acid mimetics.

As used herein, the term “nucleic acid” when used in reference to a component of a biochemical system, is intended to mean two or more nucleotides covalently bonded together such as deoxyribonucleic acid (DNA) or ribonucleic acids (RNA) and including, for example, single-stranded and a double-stranded nucleic acid. The term is similarly intended to include, for example, genomic DNA, cDNA, mRNA and synthetic oligonucleotides corresponding thereto which can represent the sense strand, the anti-sense strand or both. As with polypeptide components of a system, nucleic acid components similarly can include natural and non-naturally occurring modifications such as post-transcriptional modifications, minor substitutions and incorporation of functionally equivalent nucleotide analogs and mimetics. Such changes and methods of incorporation are well known to those skilled in the art.

Other biological molecules that are included within the meaning of the term “component” can be include, for example, macromolecules and organic and inorganic molecules that are constituents of a biochemical system. Macromolecules other than polypeptides and nucleic acids that are constituents of a biochemical system, network or pathway include, for example, lipids and carbohydrate as well as combinations of macromolecules such as glycoproteins, protoglycans, glycolipids and the like. Organic molecular constituents can include, for example, a sugar or modification thereof such as glucose or its various phosphate or acetylated derivatives. Other sugars include, for example, maltose, galactose, fructose, and xylose, derivatives thereof, and metabolites thereof, such as lactate and pyruvate. Organic molecular constituents additionally include polycyclic compounds such as steroids; building blocks of macromolecules such as nucleotides, nucleosides, amino acids, lipids, and fatty acids. Neurotransmitters such as acetylcholine and dopamine are additional examples of molecules that are constituents of a biochemical system. Exemplary inorganic and small molecules that are constituents of a biochemical system include salts, ions, and metals such as sodium, potassium, chloride, calcium, bicarbonate/CO₂, chromium, iron, and the like. Various other macromolecules, organic and inorganic molecules, are well known to those skilled in the art as constituents of a biochemical system, network or pathway. All of such constituents are intended to be included within the meaning of the term component as it is used herein.

As used herein, the term “data integration map” is intended to mean an indexed set of data elements corresponding to components that describes the interactions, interrelations, and interdependencies of the components included within the biochemical or constituent system. The description of the system interactions, interrelations and interdependencies can be arranged in a variety of formats including, for example, raw data values, mathematical, statistical, or algorithmic transformations of the raw values as well as heirarchial groupings, sets, comparisons and summaries of the raw or transformed data values. These formats as well as others known in the art are included within the meaning of the term so long as the represented data elements are indexed or cross-referenced to make known the various interactions, relationships and dependencies of the included system components. Similarly, a data integration map can include a variety of output representations that assimilate the indexed set of data elements into a desired form or structure. For example, output representations of the indexed raw or transformed data element values can be the numerical or alpha-numeric values themselves assimilated in tabular or like form. Alternatively, outputs of the indexed data elements can be in chart or graphical form, including two-dimensional and three-dimensional representations that combines the data elements in a format which maintains the indexing, and therefore, the description of interactions, interrelationships and interdependencies of the components included within the biochemical or constituent system. Such graphical output representations can combine, for example, numerical values, alpha-numerical symbols, symbols and visual components in multiple dimensions and layers as is desired to represent as many data elements as is available for combination from the described biochemical or constituent system. Depending on the described system and intended use, an indexed set of data elements can be processed, for example, manually or by computer to produce such written, pictorial, graphical, or other types of output representations.

As used herein, the term “physical interaction map” is intended to mean a data integration map that contains one or more indexed data elements which describes a physical interaction between two or more components of a biochemical or constituent system.

As used herein, the term “value set” is intended to mean a set of two or more types of data elements that characterize a component of a biochemical system. A value set can contain one or more of a particular type of data element. For example, a value set of a system component that interacts with multiple molecules can include data elements characterizing a physical interaction corresponding to each interacting molecule. A value set additionally can contain one or more different types of data elements. For example, a value set of a system component can include data elements characterizing one or more physical interactions, an mRNA expression level, polypeptide expression level, activity, system phenotype and growth rate.

As used herein, the term “data element” is intended to mean a value or other analytical representation of factual information that describes a characteristic or a physicochemical property of a biochemical system or a component of a biochemical system. A data element can be represented for example, by a number, “plus” and “minus” symbols, a particular hue or saturation of color, a geometric shape, a set of coordinates, a word, an alphanumeric string or any other descriptive form or form suitable for computation, analysis, or processing by, for example, a computer or other machine or system capable of data integration and analysis.

A data element can represent a property of a biochemical system component. For example, representations of accumulated or non-steady-state levels of nucleic acid and protein expression of a system component can be data elements. Therefore, the term “expression data element” refers to a value that represents a direct, indirect or comparative measurement of the level of expression of nucleic acid or polypeptide of a system component.

A data element can further be a representation of a physical interaction of a system component, such as, for example, a polypeptide-polypeptide interaction, nucleic acid-polypeptide interaction, nucleic acid-nucleic acid interaction, or other direct binding interaction between a polypeptide or nucleic acid with another biological molecule. Therefore, the term “physical interaction data element” refers to a value or symbol, for example, that represents a physical interaction, such as a direct binding interaction, of a component with a system component.

A data element of a biochemical system component also can include, for example, a representation of a global property of the biochemical system. For example, a cell metabolic rate, growth rate or a cellular phenotype of a biochemical system under a specified condition, can be represented by a data element.

As used herein, the term “correlative change” is intended to mean a change or alteration in a reference characteristic or property that is associated with a changed or different condition of a biochemical or constituent system. The change or alteration can demonstrate a causative, mutual or reciprocal relationship between the reference characteristic or property determined under a reference condition compared to the changed condition. The term “correlative change” when used in reference to a value set is therefore intended to mean a change or alteration in a reference value set that is associated with a changed condition of a biochemical or constituent system. The change in the reference value set determined under a reference condition compared to the value set under a different condition similarly can demonstrate a causative, mutual or reciprocal relationship or association. A correlative change in a value set includes a change in one or more data elements of the value set. Moreover, a correlative change in a value set can be relative to itself or relative to one or more other value sets between the reference condition and the changed condition. Therefore, the correlation can be with reference to a single data element, multiple data elements or all data elements of a value set. A correlative change in which two or more compared data elements behave in the same manner, such as, for example, two compared data elements that both display an increase in value, is referred to herein as a “jointly coordinated” correlative change. A correlative change in which two or more compared data elements behave in an opposite manner, such as, for example, two compared data elements in which one increases and the other decreases in value, is referred to as an “inversely coordinated” correlative change.

As used herein, the term “perturbed condition” when used in reference to a biochemical system, is intended to mean an alteration of a biochemical state or circumstances imposed on a biochemical system compared to a reference or normal state or circumstances of the biochemical system. A perturbation, to effect a perturbed condition, can include, for example, any physical modification or treatment of the biochemical system as well as exposure to any stimulus. Therefore, a perturbation can include, for example, genetic alterations, contact with macromolecules, compounds, agents and drugs, and exposure to changes in and environmental stimuli or procedural manipulations of a biochemical system.

Genetic changes useful for perturbing a biochemical system include, for example, modifications which alter the expression of a system component. Such modifications can include genetic changes that directly act on one or more system components and increase or decrease their expression. Alternatively, genetic modifications can indirectly act on one or more system components and affect their expression. For example, direct genetic changes include system component gene deletions and alterations, such as mutations or truncations that destroy or alter the expression level of a system component. Additionally, such alterations can include both increases and decreases in expression of the modified gene. Direct genetic changes are also useful for perturbing the activity or physical interactions of a system component. Indirect genetic changes useful for perturbing the expression level of a system component include, for example, deletions and alterations of regulatory elements of a system component gene and of genes encoding products that regulate the expression or are otherwise upstream components which affect the expression of a system component. Similarly, indirect genetic changes are also useful for perturbing the activity or intermolecular interactions, for example, of a system component. Other genetic changes exist as well and are well known to those skilled in the art.

Environmental changes useful for perturbing expression, activity, physical interactions or other characteristics or properties of a system component include, for example, a change in growth conditions, a temperature change, a treatment such the addition or removal of a component of growth medium, and treatment with a compound, drug, light, radiation, or other agent. Other environmental changes exist as well and are well known to those skilled in the art.

The term “perturbation state” when used in reference to a biochemical system or network, is intended to mean the characterization of the biochemical system under a specified perturbed condition.

The term “physical interaction” is intended to mean a direct binding association between two or more components of a biological system. A physical interaction includes, for example, polypeptide-polypeptide, polypeptide-nucleic acid, nucleic acid-nucleic acid interactions and interactions of other biological molecules with polypeptides and nucleic acids. A physical interaction includes, for example, binding between signal transduction components or a receptor and ligand, and the formation of a stable complex, such as that between two subunits of an enzyme that remain associated under specified conditions. Additionally, a physical interaction includes, for example, both covalent interactions, such as those between polypeptides joined by a disulfide bond, and non-covalent interactions, such as those between a transcription factor and its nucleic acid substrate. A physical interaction between two components of a system can be determined by a variety of methods well known in the art, including, for example, direct measurement, computational analysis and by probing data bases reporting such information.

The term “functionally interactive” when used in reference to a component of a biochemical system, is intended to mean a system component that exhibits two or more biochemically relevant interactions, relationships, or dependencies with another component of the biochemical system. Therefore, a functionally interactive component of a biochemical system identifies such a component as a member of at least one network or pathway of the biochemical system.

As used herein, the term “expression level” is intended to mean the amount, accumulation or rate of synthesis of a biochemical system component. The expression level of a component can be represented, for example, by the amount or synthesis rate of messenger RNA (mRNA) encoded by a gene, the amount or synthesis rate of polypeptide corresponding to a given amino acid sequence encoded by a gene, or the amount or synthesis rate of a biochemical form of a molecule accumulated in a cell, including, for example, the amount of particular post-synthetic modifications of a molecule such as a polypeptide, nucleic acid or small molecule. The meaning of the term “expression level” can be used to refer to an absolute amount of a molecule in a sample or to a relative amount of the molecule, including amounts determined under steady-state or non-steady-state conditions. The expression level of a molecule can be determined relative to a control component molecule in a sample.

A gene expression level of a molecule is intended to mean the amount, accumulation or rate of synthesis of a RNA corresponding to a gene component of a biochemical system. The gene expression level can be represented by, for example, the amount or transcription rate of hnRNA or mRNA encoded by a gene. A gene expression level similarly refers to an absolute or relative amount or a synthesis rate determined, for example, under steady-state or non-steady-state conditions.

A polypeptide expression level is intended to mean the amount, accumulation or rate of synthesis of a biochemical form of a polypeptide expressed in a biochemical system. The polypeptide expression level can be represented by, for example, the amount or rate of synthesis of the polypeptide, a precursor form or a post-translationally modified form of the polypeptide. Various biochemical forms of a polypeptide resulting from post-synthetic modifications can be present in a biochemical system. Such modifications include post-translational modifications, proteolysis, and formation of macromolecular complexes. Post-translational modifications of polypeptides include, for example, phosphorylation, lipidation, prenylation, sulfation, hydroxylation, acetylation, addition of carbohydrate, addition of prosthetic groups or cofactors, formation of disulfide bonds and the like. Accumulation or synthesis rate with or without such modifications is included with in the meaning of the term. Similarly, a polypeptide expression level also refers to an absolute amount or a synthesis rate of the polypeptide determined, for example, under steady-state or non-steady-state conditions.

As used herein, the term “pathological condition” is intended to mean a disease or abnormal condition, including an injury, of a mammalian cell or tissue. Such pathological conditions include, for example, hyperproliferative and unregulated neoplastic cell growth, degenerative conditions and infectious diseases. Numerous other abnormal or aberrant conditions are well known in the art and are included within the meaning of the term as it is used herein.

The invention provides a method of predicting a behavior of a biochemical system. The method consists of (a) comparing two or more data integration maps of a biochemical system obtained under different conditions, the data integration map comprising at least two networks, and (b) identifying correlative changes in at least two value sets between the two or more data integration maps with different conditions, wherein the correlative changes predict a behavior of the biochemical system.

Also provided is method of predicting a behavior of a biochemical system which consists of (a) obtaining a first data integration map of a biochemical system, the data integration map comprising value sets of two or more data elements for at least two networks, (b) producing a second data integration map of the biochemical system under a perturbed condition, the second data integration map comprising value sets of two or more data elements for at least two networks, and (c) identifying correlative changes in at least two value sets in the second data integration map with the perturbed condition, wherein the correlative changes predict a behavior of the biochemical system.

The methods of the invention are directed to predicting the behavior of a biochemical system. Behavioral predictions of a biochemical system include describing or forecasting the actions or state of being of a wide range of phenomenon, characteristics and properties based on application of governing system rules. Predictions of a system include describing or forecasting the behavior of the system or the behavior of individual components. Moreover, predictions similarly can include a description or projection of the behavior of higher order sets and families of components, subsystems, as well as sets and families of subsystems that are included within a biochemical system. By applying governing system rules, behaviors of a biochemical system can be predicted at the system level or at the component level, as well as at any or all of the various hierarchical sublevels of the biochemical system, including combinations thereof. Additionally, governing system rules can be applied to identify new behaviors of a biochemical system and its various included subsystems and components. The methods of the invention are applicable for both applying and determining governing system rules that describe acts, states and functions of a biochemical system and its various included components and subsystems. Such descriptions also can be applied in the methods of the invention to predict further behaviors of the system or it various included parts.

Describing or forecasting an action or state of being of a biochemical system occurs with reference to governing system rules. System rules include the functional and structural interactions, interrelations and interdependencies of the system components. Such rules dictate the characteristics and properties of a system or any of its various included components and subsystems. Governing system rules therefore include those system rules that describe the system currently or describe a reaction of the system to a changed condition or perturbation. Governing system rules also include those system rules that describe a result or an outcome of the system under a changed or future condition. Application of such governing system rules to a particular condition will predict an action or state of a biochemical system.

For example, reference to known governing system rules for a particular condition portrays the characteristics and properties of the system under that current condition. Similarly, comparison of a system's governing rules under one condition to those under a second condition provides relative differences of the system component interactions, interrelations and interdependencies. Such relative differences portray new characteristics and properties of the system and therefore the reaction and outcome to the changed and future conditions. Thus, both a description and a forecast of an action or a state of being of a biochemical system predicts the system because such characterizations portray the system, or its various included components or subsystems, either as a biochemical state with reference to a current condition or with reference to a changed or future condition.

The methods of the invention are applicable to predicting the behavior of both large and small biochemical systems alike. A system includes an interconnected array or collection of individual components forming and working as a unit. As long as one or more governing rules of the collection of working components are known or can be determined, descriptions or forecasts of an action or state of being of a phenomenon, characteristic or property of the working unit can be made using the methods of the invention. Similarly, where descriptions or forecasts of an action or biochemical state are known or can be determined, governing rules of the collection of working components can be made using the methods of the invention. Therefore, whether the working unit is referred to, for example, as a system, subsystem, network, pathway, set or group of components is unimportant to practice the methods of the invention so long as the methods are applied to a collection of components that function as a unit. Similarly, the methods of the invention also are applicable to combinations and hierarchal layers and dependencies. Thus, the methods of the inventions can be used to predict the behavior of both simple and complex systems as well as the behavior of multiple systems in a common or interactive environment.

The methods of the invention for predicting a behavior of a biochemical system are directed to assimilating individual component characteristics into an organized representation. The result of such a compilation describes or depicts global characteristics of a biochemical system. By assimilating the individual characteristics, or data representing such characteristics into an organized representation, the resulting compilation integrates factual information and attributes of the components into a map of the system. Such a map, or data integration map, therefore describes the interactions, interrelations, and interdependencies of the system components. These component relationships and the map of the system they describe are governing rules of the system.

Interactions between system components include, for example, physical interactions and the state of two or more system components influencing a characteristic of one or more components in a biochemical system. Interrelations between system components include, for example, mutual or reciprocal correlations of component characteristics in the biochemical system. Interdependencies between components include, for example, mutual causative interrelations between components. Because the governing system rules set forth by a data integration map can describe a biochemical system at the level of molecular relationships, a data integration map or comparison of maps obtained from different conditions of a biochemical system will predict behaviors of single components, a few components, groups of components, or every component in the biochemical system. Additionally, because the combined governing system rules set forth together in a data integration map describe a biochemical system at the level of the aggregate of the molecular relationships, a data integration map or comparison of maps obtained from different conditions will predict behaviors of all components as a single biochemical system. Therefore, the methods of the invention can be used to predict behaviors of a wide range of components at various levels, including the behavior of the complete system.

The methods of the invention for predicting the behavior of a biochemical system have many applications. In addition to describing or forecasting system or component phenomenon, characteristics or properties, such applications include, for example, identifying components of a biochemical system, determining functions of uncharacterized components and identifying governing system rules and system function under various or different conditions, such as normal and diseased conditions.

A specific application of the methods of the invention is the construction of a data integration map through identification and assimilation of components into networks and pathways of the biochemical system. For example, the molecular relationships governing a pathway or network function can be used to propose an initial model of the pathway or network within a biochemical system. The system is then interrogated to identify component relationships and hierarchial subsystem relationships, such as pathways and networks. For example, global system responses to a perturbation of one or more pathway components, such as mRNA and polypeptide expression levels, are used to identify a common collection of system components that are interactive, interrelated or interdependent within the initial pathway or network components. Additional system components can be added to this common collection by inclusion of system components exhibiting other common molecular relationships, such as physical interactions. Intracomponent and intercomponent characteristics of this common collection, or system, are integrated to generate a data integration map. Upon identifying a common collection of components, one can generate a data integration map representing the intracomponent and intercomponent characteristics under initial or perturbed conditions. A comparison between data integration maps obtained under initial and perturbed conditions can be made, for example, by using independent maps representing the two conditions or by integrating the relative differences into a single data integration map. Such data integration maps predict the behavior of the biochemical system relative to the conditions or perturbations from which they were derived. If desired, one or more additional perturbations can be made to further expand the data integration map. A data integration map can be expanded to include additional pathways and networks, and if desired, all of the pathways and networks of the biochemical system.

The methods of the invention for predicting a behavior of a biochemical system involve comparing two or more data integration maps. Two or more data integration maps can be compared by determining the differences between data elements in value sets that describe characteristics of each component represented in a data integration map. The methods used for determining such differences will depend upon the type of data element examined, since a data element can be represented in a variety of ways. For example, determining a difference between two data elements can involve a mathematical calculation when data elements are represented by numbers, can involve combining or subtracting symbols that represent data elements, such as, for example, combining or subtracting “plus” or “minus” signs, and can involve adding or removing words representing physical interaction partners of a component. A difference between two mRNA or polypeptide expression data elements can be determined, for example, by calculating a mathematical difference in absolute or relative numerical values representing expression levels. A difference between a physical interaction data element of a component can be determined, for example, by identifying any lost or gained physical interactions. Such determinations or calculations can be performed manually, using a computer associated with analytical instrumentation, or any computer program or machine capable of calculating, identifying or listing differences in data elements of two or more data integration maps.

Differences between data elements representing characteristics of components of a biochemical system can be organized using any format, such as, for example, a table, list, or spreadsheet. The differences can be represented, for example, in a chart, graph, pictue, two-dimensional, or three-dimensional representation. A representation of the differences between two or more data elements of each component within two networks of a biochemical system is a comparative data integration map that can be used for predicting the behavior of a biochemical system using the methods of the invention.

Comparisons between two or more data integration maps can involve comparing data elements of every component of a data integration map, a subset of components, components of one or more specific networks or pathways, as well as many, several or a few components from common or different pathways or networks. Comparisons between two or more data integration maps can involve selecting for comparison two or more data elements contained within the value sets of each component to be compared. It is not necessary that all components of a data integration map have the same data elements compared.

The methods of the invention for predicting a behavior of a biochemical system involve obtaining a first data integration map of a biochemical system. A first data integration map can be obtained from any source. For example, a previously prepared data integration map can be used or a data integration map can be produced using the methods described herein. A first data integration map can describe an unperturbed or perturbed condition of a biochemical system.

Producing a data integration map involves preparing an indexed data base, list or other organized data format containing the data elements that characterize each component of a biochemical system, constituent system, or subsystem thereof. Therefore, producing a data integration map useful in the methods of the invention involves identifying two or more data elements that describe characteristics of components contained in at least two networks. A data integration map can be produced from several starting points, depending on whether data elements of network components have been identified and whether components of a biochemical network have been identified. For example, previously identified data elements describing components of two networks can be used to produce a data integration map. In such a case, the data elements are formatted in such as way as to describe the interactions, interrelations, and interdependencies of the biochemical system or constituent system to produce a data integration map. Using methods well known in the art, and those described herein, data elements describing components of a biochemical network can be obtained and used to produce a data integration map. Methods described herein can be used to identify additional components of a network containing a few or many components as well as to identify a biochemical network de novo.

Producing a data integration map involves determining the data elements desired for describing the interactions, interrelations, and interdependencies of components of a biochemical-system. The types of data elements selected for producing a data integration map will depend on what behaviors of a biochemical system are to be predicted, as well as what types of measurements are feasible for a particular system. The selected component characteristics incorporated into a data integration map will produce a data integration map that can be used to describe the system rules in reference to the selected characteristics. For example, a data integration map having data elements describing expression, activity, and physical interaction, can be used for describing the system rules in terms of expression, activity and physical interaction. Comparison of two such data integration maps allows the prediction of behaviors of a biochemical system described by expression, activity and physical interaction. A data element can represent any factual characteristic of a biochemical system component that it represents, such as, for example, nucleic acid expression, protein expression, polypeptide-polypeptide interaction, nucleic acid-polypeptide interaction, metabolite abundance, and growth rate.

The number of data elements selected for inclusion in a value set depends on the desired complexity of the data integration map produced. For example, a greater number of data elements in each value set is advantageous for predicting a behavior of a biochemical system since a greater number of component characteristics will be represented, and can be selected from to describe the behavior of a biochemical system. Therefore, a value set can include at least two or more, three or more, four or more, five or more, or a greater number of data elements. Those skilled in the art will know the types of characteristics of a biochemical system or system component are useful for predicting a behavior of the selected biochemical system. Similarly, those skilled in the art will know the characteristics of a biochemical system that are measurable and how to make measurements on a global level, if desired.

A data integration map useful in the methods of the invention for predicting the behavior of a biochemical system describes at least two networks contained in a biochemical system. The number of networks represented by a data integration map will depend on the number of associated networks identified within a biochemical system. Two or more biochemical networks share at least one interacting, related or dependent component. The number of networks represented by a data integration map can also be a subset of known associated networks. A data integration map that represents all known networks of a biochemical system provides the advantage of predicting a behavior of a biochemical system using the maximum number of known components. Therefore, a data integration map can contain two or greater than two, three, four of five networks, depending on the known network components and the desired application of the data integration map.

The two or more networks described by a data integration map contain at least one network component that has an interaction, interrelation or interdependency with a component of another network described in the data integration map. The number of components in a network represented by a data integration map will depend on the number of components known, or identified using the methods of the invention, to be contained in the network. A subset of network components can be selected by the user for inclusion in a biochemical network. Therefore, a data integration map can describe substantially all of the known components, or a subset of the known components of two or more networks. The number of network components described in a data integration map can be, for example, at least two, three, four, five, six, seven, eight or nine or more components.

A data integration map can describe a variety of characteristics of a biochemical system component. Such characteristics of a component can include, for example, those characteristics represented by data elements, such as values representing relative quantities of mRNA or polypeptide present in one or more specific perturbation states, as well as other characteristics such as, for example, an identifying name, one or more known or predicted cellular functions, phylogenetic information, nucleic acid and amino acid sequences, references to related components, database entries, relevant literature references, values representing a particular gene cluster containing the component, physicochemical properties, as well as other information relevant to the identity, interactions, interrelations and interdependencies of the component. The user will know what types of information are useful for representing components of a biochemical network or system.

A data integration map can contain components characterized by a variety of types of data elements. A representation of a data integration map will have a form suited to the types of data elements describing the components included in the data integration map. Therefore, output representations of indexed raw or transformed data element values or sets of such values presented in graphical form can be distinct when describing sets of different types of data elements, such as, for example, expression and physical interaction or expression and activity. Although a data integration map can have a variety of forms and appearances, it will describe the interactions, interrelations, and interdependencies of the components of the biochemical system that it represents.

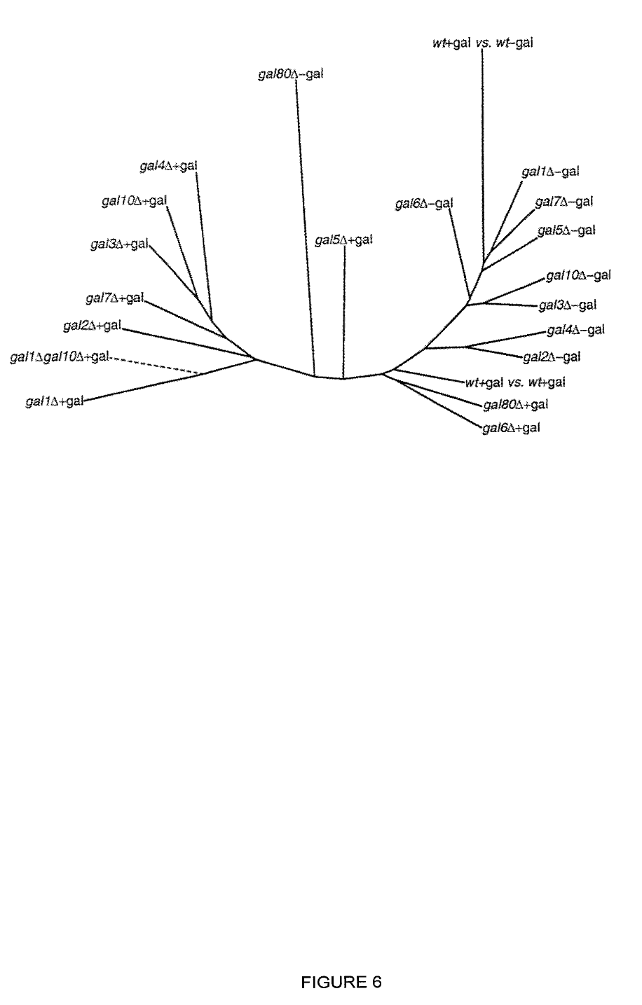

A data integration map can be represented in a variety of formats, including, for example, as raw data values, mathematical transformations of raw values, a set or summary of raw or transformed values, tabular, chart, and graphical forms, including three-dimensional representations. An exemplary graphical format for representing a data integration map is described, for example, in FIGS. 5 and 6. The exemplary graphical format depicts system components by presenting the name of the component within a geometrical shape. Physical interactions between components are shown by lines, with or without arrows, connecting interacting components. Polypeptide-polypeptide, polypeptide-nucleic acid, and nucleic acid-nucleic acid interactions are distinguished using arrows. Expression levels of mRNA and polypeptides are represented by shading. A variety of visual representations can be used to represent the data elements in a data integration map. Color hue and intensity, line thickness, depiction of three-dimensionality, geometric shape and size are examples of readily recognized visual parameters. Comparative data integration maps can similarly use any visual parameter to represent degrees of change between data elements in two or more biochemical systems.

A data integration map can therefore be described by an output representation, such as a chart, graph, or three-dimensional representation. An output representation can be prepared by processing raw or transformed data values manually or by computer, using a variety of algorithms well known in the art. The exemplary graphical representation of a data integration map shown in FIG. 5a, for example, was created using a program based on GraphWin (Mehlhorn, K and Naeher, S. The LEDA Platform of Combinatorial and Geometric Computing, Cambridge University Press, Cambridge, (1999)). The figure depicts 348 “nodes” and 362 “common characteristics”, where each node represents a component of a biochemical system, and connections between nodes represent a common characteristic between components, a polypeptide-polypeptide or polypeptide-DNA interaction. The common characteristic of relative changes in expression of components, are depicted by grayscale intensity and size of nodes. Physical interactions between two genes whose mRNA expression levels are both significantly altered appear in bold, as opposed to dotted lines, and nodes representing system components for polypeptide expression data, in addition to mRNA expression data, were obtained contain an additional, inner circle representing the change in polypeptide expression.

Producing a data integration map involves determining correlative changes between components of a biochemical system under two or more different conditions. Alterations in data elements that correspond to a particular condition of a biochemical system can be detected by comparing values representing data elements of system components under the different conditions. Each component described by a data integration map has a value set containing data elements that describe characteristics of each component, such as, for example, expression level, activity and physical interactions. Comparing the characteristics of biochemical system components under different conditions therefore involves comparing the data elements of the components of each biochemical system. Correlative changes among data elements of components of a biochemical system can describe the interactions, interrelations and interdependencies of system components because correlative changes reveal components that regulate characteristics of each other, or are co-regulated by a common component. For example, a perturbation of a single component of a biochemical system can result in alterations of one or more characteristics of system components that interact with, are regulated by, or whose regulation is affected by the perturbed component. These relationships between components are evidenced by both jointly coordinated and inversely coordinated changes in component characteristics. Value sets contain data elements that are suitable for processing by a computer. Therefore, determination of correlative changes between biochemical system components can be performed manually or using a computer. Similarly, differences between values of data elements in a comparative data integration map can be prepared manually or using a computer.

A data integration map can represent a state of a biochemical system under a particular condition or the difference between two or more biochemical systems under different conditions. Therefore, two or more data integration maps, each representing a different condition of a biochemical system, can be compared, or a comparative data integration map describing the differences between the two or more conditions of the biochemical system can be produced. A comparative data integration map is particularly useful for predicting a behavior of a biochemical system because the differences between the biochemical systems can be made readily accessible through visual representations.

The comparison of two or more data integration maps involves comparing correlative changes among two or more types of data elements which characterize one or more components of a biochemical system under two or more different conditions. For example, correlative changes in a single component, a few components, many components or substantially all of the components of a biochemical system can be compared between two or more conditions of a system. Correlative changes can be identified for components in any network described by a data integration map. Therefore, correlative changes of components from a single network, more than one network, or substantially all networks described by a data integration map can be determined in order to predict the behavior of a biochemical system. Comparisons can similarly be made between two or more different biochemical systems.

A comparison of data integration maps obtained from for a biochemical system under two different conditions, such as an unperturbed biochemical system and a perturbed biochemical system, can be used to describe the differences or changes in the governing system rules of a biochemical system under a perturbed condition. A perturbation to a biochemical pathway can result in changes within the pathway components, changes in the network containing the pathway and changes in other networks. A perturbed biochemical system contains at least one component having an altered characteristic compared to the unperturbed system. A data integration map of a perturbed biochemical system, by describing these altered component characteristics, indicates a set of governing system rules of the biochemical system different from the governing system rules of the unperturbed system. A behavior of a biochemical system or system component can be predicted or determined by observing the governing system rules of a perturbed biochemical system, or by determining the differences in the governing system rules between an unperturbed and perturbed biochemical system. By comparing two data integration maps obtained under different conditions of a biochemical system, a difference in a characteristic of a component of a biochemical system under a specified condition describes the biochemical system under the rules of the specified condition. Thus, it is known that under the system rules of the perturbed conditions, a particular change or difference in a characteristic of a component exists. Therefore, changes that characterize a system under a specific perturbation can be used to identify a system having that specific perturbation state when the state of the system under study is not known.

The methods of the invention for producing a second data integration map under a perturbed condition and identifying correlative changes in at least two value sets in the second data integration map can be repeated one or more times, as desired, to describe the interactions, interrelations, and interdependencies of components of a biochemical system in greater detail.

The methods of the invention for predicting the behavior of a biochemical system involve obtaining a data integration map describing a different or perturbed biochemial system. A perturbation of a biochemical system includes any type of condition that alters a characteristic of a biochemical system component. A perturbation can be applied to any type of component of a biochemical system, such as, for example, a gene, polypeptide, macromolecules and organic and inorganic molecules. Thus, a perturbation to a biochemical system can be applied, for example, by altering or perturbing a characteristic of a component of a biochemical system, directly, indirectly, or both. A direct perturbation is an alteration of a component that is independent of the characteristics of other system components. A direct perturbation of a system component includes a genetic manipulation that specifically alters a property of the component, such as expression, activity or physical interaction. For example, the expression of a component can be altered by gene overexpression, deletion or mutation, and by mutation of a gene that positively or negatively regulates component gene expression.

The activity of a component can be altered, for example, by mutation of the component gene that results in a component polypeptide having altered activity. Gene mutations include, for example, nucleotide substitutions, deletions, truncations, and fusions with heterologous nucleic acids. Altered activity can be an increase or decrease in functional activity, a change in conformation that alters function or binding to another molecule, or a change that results in altered modification, such as increased or decreased phosphorylation, glycosylation, or other polypeptide modification. A direct perturbation can include a change in any system component characteristic represented by a data element.

An indirect perturbation of a system component can be a change in the cellular environment containing the system component that results in a change in a characteristic of the component, such as, for example, expression, activity or physical interaction. An indirect perturbation of a component can be, for example, an environmental manipulation of an organism or cell that alters a characteristic of a system component. For example, changes in temperature, nutrition, introduction or withdrawal of certain factors from growth medium, and treatment with drugs can be used to alter a characteristic of a component. An indirect perturbation can be used to alter a system component characteristic represented by a data element.

A perturbed biochemical system can contain multiple perturbations. For example, perturbations can be made to components contained within distinct networks or to more than one component in a particular network, including substantially all of the components of a network or pathway. In addition, a combination of direct and indirect perturbation of one or more components of a biochemical system can be performed. For example, a direct perturbation such an alteration of a component that results in a change in component expression, activity, or physical interactions can be combined with an indirect perturbation such as an environmental perturbation that initiates the biochemical function of the perturbed component. A specific example of a combination of direct and indirect perturbations useful in the methods for predicting the behavior of a biochemical system and identifying a component of a biochemical network is the deletion of a component gene involved in a extracellular ligand stimulated signaling cascade pathway, combined with the indirect environmental perturbation of ligand addition to the biochemical system to initiate the signaling cascade pathway. Thus, a perturbed biochemical system can have one, two, three, four, five, six, seven, eight, nine, ten or more perturbed conditions.

The invention provides an additional method of predicting a behavior of a biochemical system. The method consists of (a) obtaining a first physical interaction map of a biochemical system, the physical interaction map comprising value sets of a physical interaction data element and an expression data element for at least two independent networks; and (b) producing a second physical interaction map of the biochemical system under a perturbed condition, the second physical interaction map comprising value sets of a physical interaction data element and an expression data element for at least two independent networks, and (c) identifying correlative changes in at least two value sets in different independent networks in the second physical interaction map with the perturbed condition, wherein correlative changes predict a behavior of the biochemical system.

A physical interaction map is a type or subset of a data integration map which describes components having that contains value sets that include a physical interaction data element. As such, a physical interaction map describes the physical interactions between biochemical system components, as well as at least one other type of interaction, interrelation, of interdependency between components of a biochemical system. Therefore, the methods of the invention for predicting the behavior of a biochemical system using a data integration map can be applied to predicting the behavior of a biochemical system using a physical interaction map.

A physical interaction map, like a data integration map, can be obtained from any source. A physical interaction map can be produced in the same manner as a data integration map that contains a physical interaction data element for each represented biochemical system component, as described herein. Specific examples that describe the process of producing a physical interaction map are provided below in reference to identifying a component of a biochemical system. The methods for producing a data integration map or physical interaction map involve first selecting the types of data elements to be included in the map. For example, the components represented by a physical interaction map are characterized by at least one physical interaction data element and one or more other type of data element, such as those representing, for example, a component activity, expression level, or other characteristic, or a characteristic of a biochemical system, such as a phenotype, production of a metabolic product, or growth rate. Like a data integration map, a physical interaction map can describe the governing system rules or state of a biochemical system under a specified condition or the differences in the system under two or more different conditions.

A physical interaction map describes the intermolecular interactions of the represented components of a biochemical system and at least one other common characteristic of the system components. A physical interaction map can therefore include the interactions between any type of component of a biochemical system, including, for example, interactions between polypeptides, nucleic acids and other molecular constituents of a biochemical system. Such intermolecular interactions include, for example, polypeptide-polypeptide, polypeptide-nucleic acid, nucleic acid-nucleic acid, and polypeptide or nucleic acid interactions with other molecules. Any other characteristic of a component represented by a data element, as described above in reference to producing a data integration map, can be included in value sets of components described by a physical interaction map.

A physical interaction map can include all identified interacting pairs, a subset of interacting pairs, or can be restricted as desired. As described herein in Example III, the components of a physical interaction network can be restricted to a set of components affected by at least one perturbation combined with a set of components unaffected by the perturbation but involved in two or more physical interactions with one or more components in the set of components affected by the perturbation. Thus, a component having a value set containing two or more physical interaction data elements that represent physical interactions with two or components a biochemical pathway, network or system, can be selected for inclusion into a physical interaction map, if desired.

Like a data integration map, a physical interaction map can contain more than two, three, four, five, six or more networks, depending on the natural or desired complexity of the biochemical system under examination.

The invention provides a method of identifying functionally interactive components of a biochemical system. The method consists of (a) obtaining a set of components within a biochemical system linked by physical interactions, (b) obtaining a set of components within a biochemical system linked by expression or activity, and (c) integrating the set of physically linked components with the set of components linked by expression or activity to produce a network of components functionally interactive within the system, each component within the physical interaction network being characterized as having at least one physical interaction with a component within the set of components linked by expression or activity.

The methods of the invention for identifying functionally interactive components of a biochemical system are useful for identifying a network of common components. The components of a network of common components can include the components contained in a biochemical network or pathway. Thus, the methods for identifying functionally interactive components can be used, for example, to identify components of a biochemical pathway or network. A component of a network of common components has at least two characteristics in common with other common components. The common characteristics can be, for example, levels of expression or activity of a component, physical interaction, and characteristics of a biochemical system containing the component under a specified condition. As described above in relation to identifying correlative changes between components of a biochemical system under two or more conditions for the preparation of a data integration map, common characteristics of components of a network of common components can be determined by identifying correlative changes between components under two or more different conditions of a biochemical system. A common component that is functionally interaction within the system is a component that has at least two characteristics in common with other components of a network of common components.

The methods of the invention for identifying a functionally interactive component of a biochemical system involves obtaining a set of components within a biochemical system linked by a component characteristic. The components contained in a set of components linked by a component characteristic each have a characteristic, such as that represented by a data element, that is shared or that undergoes a mutual or reciprocal change under a common specified condition of a biochemical system. Components can be linked, for example, by physical interaction, expression, activity, phenotypic change and metabolite abundance.

A set of components linked by physical interaction contains components that each have at least one physical interaction with another component of the set. A set of components linked by expression or activity each have altered expression or activity under a specified condition of a biochemical system. For example, a set of components linked by expression or activity can be obtained by perturbing a biochemical system, determining changes in expression or activity, and identifying a set of components that underwent a change correlating with the perturbation. Components linked by a global characteristic of a system, such as metabolite abundance, for example, share a common characteristic of a level of a particular metabolite.

The methods of the invention for identifying functionally interactive components of a biochemical system involve integrating a set of components linked by two or more common characteristics. A specific example is the integration of a set of physically linked components with a set of components linked by expression or activity, as described, for example, in Example III. The exemplary method involves identifying all of the physical interactions known for a particular biochemical system, determining changes in expression or activity of the components of the biochemical system under two or more different conditions, and retaining components that have both a physical interaction with another system component and an alteration in expression or activity under a specified condition of a biochemical system. The method could also be practiced by determining all of the system components that are different or undergo a change between two or more different conditions of a biochemical system, and then determining which of those components physically interact with another component of the subset of the biochemical system that has altered expression or activity under a specified condition of a biochemical system. Similarly, other characteristics of a biochemical system or system component can be integrated to identify components of a network of common components.

The invention provides a method of identifying a component of a biochemical network. The method consists of (a) preparing a physical interaction map between two or more system components; (b) identifying a system component exhibiting altered expression or activity in response to perturbation of a pathway component, and (c) refining the physical interaction map to include a pathway component, an altered system component and an unaltered system component exhibiting at least one physical interaction with an altered system component, the refinement identifying at least one component of a biochemical interaction network by inclusion into said physical interaction map.

Another method for identifying a component of a biochemical network consists of (a) perturbing the expression or activity of at least one pathway component; (b) measuring a response of one or more pathway components; (c) determining physical interactions between one or more system components and one or more pathway components to identify candidate network components, and (d) determining a change in expression or activity of a candidate network component affected by the perturbation of at least one pathway component, wherein a candidate network component exhibiting a change in expression or activity is identified as a component of the biochemical network.

The methods of the invention for identifying a component of a biochemical network involve perturbing a biochemical pathway component and identifying biochemical system components that respond to the pathway perturbation by an alteration in a component characteristic. Due to the sequential relationship among pathway components, described in detail below, disruption or alteration of one component of a pathway alters the biological function of the pathway. An alteration in the biological function of a pathway can be manifested in a variety of ways, depending on the particular perturbation and function of the pathway. For example, the function of a biochemical pathway can be enhanced, inhibited, terminated at a particular step or stage or can affect a different outcome from a normal function, in response to a perturbation of a pathway component.

A perturbed biochemical pathway can also affect the biochemical function of a biochemical network containing the perturbed pathway. For example, a biochemical pathway can result in the production of a product that initiates the biochemical function of another biochemical pathway. Lack of production of such a product, such as through a perturbation of a biochemical pathway, would therefore alter the biochemical function of the second pathway which would be initiated under unperturbed conditions. Therefore, components of a biochemical system that are altered in response to a perturbation of a biochemical pathway component are contained within the biochemical network of the perturbed pathway.

The methods for identifying a component of a biochemical network can be applied to identifying biochemical network components de novo, or to identifying system components to be added to a biochemical network having known components.

The methods of the invention for identifying system components to be added to a biochemical network involve preparing a physical interaction map between two or more system components. As described above, a physical interaction map represents the intermolecular interactions that link together the components of the network, and at least one other characteristic shared by network components that links together the components into a biochemical network. To identify a system component that is contained in a biochemical network, a pathway component of a biochemical network represented on the physical interaction map is perturbed. The response of biochemical system components to the perturbation is determined. A response of a biochemical system component can include, for example, a change in expression, activity, or physical interaction.

A biochemical system component having a characteristic that is altered in response to such a perturbation is added to the physical interaction map. A characteristic of a system component that is altered in response to a perturbation can be, for example, a characteristic also altered among biochemical network components represented on the physical interaction map, or can be a different characteristic. Inclusion of a system component into a physical interaction map is referred to herein as refining a physical interaction map to include a component of a biochemical network.

The methods of the invention for identifying a component of a biochemical network can be used, for example, to determine the components of a biochemical network from the starting point of having identified one or more pathway components known, or suspected, to be contained in a particular biochemical pathway. The methods involve perturbing the known or suspected pathway component, measuring a response of system components in response to the perturbation, determining the physical interactions between system components that had an altered response to the perturbation, and determining a subset of biochemical system components that have both an altered characteristic in response to a perturbation of a particular pathway, and a physical interaction with a component of the biochemical system. A set of components contained in a biochemical network determined using this method can be represented by a physical interaction map since each component will be described by a physical interaction data element.

The components of a biochemcial pathway are interrelated in a sequential manner. The relationship between components of a biochemical pathway can be understood, for example, by the following representation. A pathway composed of components A, B, and C, that produces a product, D, requires the function of A, B, and C in a sequential manner. A disruption in component A will disrupt the function of B and C, disrupting the production of product D. The relationship between pathway components can be represented, for example, by interconnecting lines. A pathway component can have a relationship with one or more components outside of the pathway. For example, if component B physically interacts and has another type of data claim common with E and F with two additional system components, E and F, the relationship of component B with A, C, E, and F, could be represented by B at a hub with spokes connecting to A, C, E, and F.

The methods of the invention for identifying a component of a biochemical system involve perturbing a biochemical pathway component. A biochemical pathway component selected for perturbation can be known or suspected to be involved in a specific biochemical pathway. A perturbation of a pathway component will effect a response of a pathway component. Those skilled in the art will be able to determine a response of a pathway component that will reflect the biochemical function of the pathway, such that, for example, a disruption of a biochemical pathway can be detected. For example, a biochemical pathway can include an enzymatic pathway that results in conversion of one compound to another. A response of a component of such a biochemical pathway can be, for example, production of the product compound or an enzymatic activity.

Another example of a biochemical pathway is a gene expression pathway. A response of a component of a gene expression pathway can be, for example, expression or lack of expression of a particular gene. A further example of a biochemical pathway is a regulatory pathway. A response of a component of a regulatory pathway can be, for example, enzymatic activity, metabolite or product production, gene expression or any other characteristic of a component of the perturbed biochemical system that reflects the biochemical function of the regulatory pathway. Those skilled in the art will know or can determine methods for measuring a response to a pathway component perturbation in a particular biochemical system. Such a response can be measured, for example, relative to a reference condition of a biochemical system, such as an unperturbed state of the system.

Methods for making perturbations of a pathway will vary depending on the biochemical system. Those skilled in the art will know which perturbations are expected to affect a particular biochemical pathway, and how to make the perturbation for their specific biochemical system. Methods for making genetic and environmental perturbations are well known in the art. Various types of genetic and environmental perturbations are described herein, and in Example II.

The methods of the invention for perturbing a characteristic of at least one pathway component can also be applied to at least two, three, four, five, or more pathway components. Any number of pathway components can be perturbed in order to identify a component in a biological network. For example, a single component, a few, many or every component known to participate in a particular pathway can be subjected to perturbation, if desired. The methods of indentifying components of a biochemical network can include perturbing more than one component of a biochemical pathway because each perturbation can lead to the identification of additional components of a biochemical network. When it is desired to identify all components of a biochemical network, for example, perturbation of all known components of a biochemical pathway is advantageous. Components of a biochemical pathway can be perturbed individually, or more than one pathway component can be perturbed to produce a perturbed biochemical system.

Candidate components of a biochemical network can be determined by identifying components that have a characteristic in common with a pathway component. For example, a system component that has an interaction with a pathway component is a candidate component of the network. A group of candidate components can therefore be determined by identifying system components that interact with pathway components. The components of a pathway function in a sequential manner such that affecting one component of a pathway, such as by perturbing the component, can affect a response of other components in the pathway. Similarly, perturbation of a pathway component can affect the response of a component in the network containing the pathway. Therefore, a candidate network component exhibiting correlative changes in two or more types of data elements as a result of a pathway perturbation, such as a change in expression or activity, is identified as a component of the biochemical network.

The methods of the invention for identifying a component of a biochemical network involves refining a physical interaction map to include a pathway component, an altered system component and an unaltered system component exhibiting at least one physical interaction with an altered system component. Refining the physical interaction map is adding to the physical interaction map a biochemical network component. A component of a biochemical network is characterized by having correlative changes in two or more types of data elements which represent characteristics, such as altered expression, activity, or other characteristic represented by a data element, in response to a perturbation that effects components of the particular network, including one physical interaction with a component in the biochemical network.

The methods of the invention for producing a data integration map or physical interaction map involve determining physical interactions between system components. Physical interactions between two or more components can be demonstrated using a variety of experimental methods well known in the art, such as, for example, the yeast two-hybrid system, phage display, co-immunoprecipitation, co-purification, and co-sedimentation, and gel-shift assays. Physical interactions between system components can also be obtained by searching the literature and public or private data bases. For example, the Database of Interacting Proteins, available at the UCLA web site, is a compilation of experimentally determined yeast protein interactions (Xenarios, I. et al., Nucleic Acids Res. 28, 2890-291 (2000)). Those skilled in the art will know how to do a manual or computer-assisted search of the literature or a data base to identify reported physical interactions between system components.

In one embodiment, the methods of the invention involve perturbing a component of a biochemical pathway, determining the global effects of the perturbation on system components, integrating observed changes in system components with a physical interaction map, and refining the physical interaction map to include newly identified components of a biochemical network. An advantage of this method is that the interconnection between cellular pathways can be identified. For example, the method has been used to uncover the previously undetected interplay between yeast galactose utilization and metabolic pathways. The method can be applied to a variety of systems, including human cells and tissues, to define and characterize a biochemical network in terms of its components and pathways, and to determine and predict the cellular functions of biochemical network components.

In one embodiment, the methods of the invention for identifying a component of a biochemical network can be performed in three steps, as described below. The first step involves defining the genes, mRNAs, polypeptides, and other components that constitute the cellular pathway of interest. Such components can be defined experimentally, using computational methods include pathway or extracted from the literature and public databases. Experimental identification of pathway components can be performed using classical genetic and biochemical approaches, genome-wide approaches such as genomic sequencing, proteomics methods, nucleic acid microarrays and other global measurement tools, or a combination of methods.

The second step in the process involves the perturbation of one or more components in the pathway through one or more manipulations. For example, genetic and environmental changes can be used to alter the expression or activity of one or more pathway components. The global cellular response to each perturbation can be monitored using a variety of methods as described herein.

The third step in the process of identifying a component in a biochemical network involves integrating observed mRNA and protein responses with a model of the pathway and with the global network of protein-protein, protein-DNA, and other known physical interactions. The final step in the process of identifying a component is a biochemical network involves refining the network model and proposing new hypotheses that form the basis for additional perturbation experiments.

In one embodiment, each component of a biochemical pathway is perturbed by genetic deletion. Each strain, or biological system, is then subjected to a nutritional perturbation that initiates or inhibits the galactose utilization pathway. In the context of the galactose utilization pathway being on or off, the effect of perturbing each pathway component is examined from a global perspective. The method advantageously combines mRNA and protein expression profiles obtained for each mutant yeast strain in the presence and absence of galactose utilization with a physical interaction map containing the protein-protein and protein-nucleic acid interactions known to exist among the genes.

Each gene on the physical interaction map can be referred to as a node. An alteration in the expression or activity of a network component can be visualized on a physical interaction map by highlighting a node with any convenient annotation, such as, for example, color, shading, symbols, shapes and sizes of shapes. Thus, each perturbation produces a distinct pattern of highlighted nodes on a common underlying network topology. By observing the effects of perturbations of each of the nine genes involved in the pathway, the impact of the perturbation on network components within and outside of the pathway becomes evident. In addition to confirming major features of the classical model of galactose utilization in yeast, the methods of the invention were useful for expanding the model in surprising directions by demonstrating that the galactose-utilization pathway is interconnected to a variety of other pathways, particularly those associated with cellular metabolism.

The invention provides a method of screening for compounds that restore a perturbation state of a biochemical system. The method consists of (a) obtaining a data integration map of a perturbed biochemical system, the data integration map comprising at least two networks; (b) contacting a biochemical system exhibiting a perturbation state corresponding to the data integration map with a test compound, and (c) producing a second data integration map of the biochemical system contacted with the test compound, a compound that restores perturbed states in at least two value sets of said data integration map to unperturbed states indicating that the compound has biochemical system restoring activity.

The methods of the invention for screening for compounds that restore a perturbation state of a biochemical system involve obtaining a data integration map of a perturbed biochemical system. Obtaining a data integration map is described above in reference to the methods of producing a data integration map. A data integration map describes the state of a biochemical system in terms of the interactions, interconnections and interdependencies of system components. Thus a comparison between data integration maps can reveal changes in data elements of one or more pathways and networks present in a perturbed system. A data integration map obtained from a perturbed biochemical system can have one or more altered data elements compared to a reference data integration map obtained, for example, from a corresponding unperturbed system. The effect of a test compound on at least two networks of a perturbed biochemical system can be readily observed by comparing a data integration map from a perturbed sample in the presence and absence of the test compound. The effect of a test compound on components can be observed in a multi-network level, the method thereby providing an advantage over conventional screening methods that typically measure the effect of a compound on a single component or pathway. An additional advantage provided by the methods of the invention, as applied to screening test compounds, is that test compounds can be selected based on the network components observed to be affected in the perturbation state of a sample compared to an unperturbed sample. For example, test compounds suspected or known to modulate a particular cellular function can be administered to a system having a perturbation of the corresponding biochemical network.

The invention provides a method of identifying compounds that restore a perturbation state of a biochemical system. A perturbation state of a biochemical network is a condition of a biochemical system in which one or more network components have a characteristic, such as a level of expression or activity, that is altered from the level of expression or activity of the component in the unperturbed state of the biochemical system. A cell or organism containing a perturbation state of a biochemical network can be generated experimentally or obtained from a natural source. A perturbation state of a biochemical network can be generated using a variety of experimental methods, such as, for example, genetic and environmental perturbations, as described above. Therefore, cells or organisms having gene deletions or altered expression levels of a network component, and cells or organisms subjected to an environmental change such as treatment with a drug, contain a biochemical network having a perturbation state.

A perturbation state of a biochemical system can also be caused by or result from a disease or other abnormal state of an organism, including genetic abnormalities. Therefore, a cell or organism containing a either a naturally occurring or induced perturbation state of a biochemical system is applicable to the methods of the invention.

The methods of the invention for screening for compounds that restore a perturbation state of a biochemical system involve contacting a biochemical system exhibiting a perturbation state with a test compound. A test compound can be any substance, molecule, compound, mixture of molecules or compounds, or any other composition which is suspected of being capable of restoring a perturbation state of a biochemical system. A test compounds can be a macromolecule, such as biological polymer, including polypeptides, polysaccharides and nucleic acids. Sources of test compounds which can be screened for restoring a perturbation state of a biochemical system, for example, libraries of small molecules, peptides, polypeptides, RNA and DNA.

Additionally, test compounds can be preselected based on a variety of criteria. For example, suitable test compounds having known modulating activity on a pathway suspected to be involved in a perturbation state of a biochemical system, as determined using the methods described herein, can be selected for testing in the screening methods. For a biochemical system that has been determined to contain components that participate in more than one pathway, test compounds suspected or known to modulate each pathway can be examined for the ability to restore a perturbation state of a biochemical system using the screening methods of the invention. Alternatively, the test compounds can be selected randomly and tested by the screening methods of the present invention. Test compounds can be administered to the reaction system at a single concentration or, alternatively, at a range of concentrations from about 1 nM to 1 mM.

The method of screening for compounds that restore a perturbation state of a biochemical network can involve groups or libraries of compounds. Methods for preparing large libraries of compounds, including simple or complex organic molecules, carbohydrates, peptides, peptidomimetics, polypeptides, nucleic acids, antibodies, and the like, are well known in the art. Libraries containing large numbers of natural and synthetic compounds can be obtained from commercial sources.

The number of different test compounds examined using the methods of the invention will depend on the application of the method. It is generally understood that the larger the number of candidate compounds, the greater the likelihood of identifying a compound having the desired activity in a screening assay. The methods can be performed in a single or multiple sample format. Large numbers of compounds can be processed in a high-throughput format which can be automated or semi-automated.

A reaction system for identifying a compound that can restore a perturbation state of a biochemical system contains a mixture of the components of a biochemical system that can be modulated by a test compound. For example, a test compound can be administered to an organism, intact cell or cell preparation in which two or more network component alterations in expression or activity can be modulated by the test compound. The modulation of a biochemical network by a test compound can be determined by measuring changes in expression or activity of one or more network components.

A compound that restores a perturbation state of a biochemical system changes at least two value sets of a data integration map of a perturbed biochemical system to unperturbed expression or activity levels. Changes in data elements of value sets can be determined using a method appropriate for the specific data element. A test compound that restores a value set of a perturbed biochemical system to at least about 50% of the normal unperturbed level of an expression or activity data element is considered to be a compound that restores a perturbation state of the biochemical system.

Therefore, the invention provides a method of screening for compounds that restore a perturbation state of a biochemical system that can be applied to a sample derived from a perturbed biochemical system contained in any cell or organism for which a suitable unperturbed reference sample can be obtained.

The methods of the invention for screening for compounds that restore a perturbation state of a biochemical system involve obtaining a data integration map of a perturbed biochemical system, the data integration map comprising at least two networks. The data integration map can comprise at least three, four, five, six, seven, eight, nine or more networks, depending on the natural or desired complexity of the system.

The methods of the invention for screening for compounds that restore a perturbation state of a biochemical system involve producing a second data integration map of the biochemical system contacted with the test compound. A second data integration map of the biochemical system contacted with the test compound can be produced by treating the biochemical system with a test compound under conditions in which a biochemical system can respond to a test compound. A biochemical system treated with a test compound can then be subjected to analytical methods for detecting a change in one or more selected data elements. Prior to analysis, a biochemical system can be processed in a manner appropriate for the method of detection.

The invention provides a method of diagnosing or prognosing a pathological condition. The method consists of (a) comparing a data integration map of a biochemical system for an individual suspected of having a pathological condition to one or more data integration maps of the biochemical system produced from an individual exhibiting a known condition, the data integration maps comprising at least two networks, and (b) identifying a data integration map representing the known condition that is substantially the same as the data integration map for the individual suspected of having a pathological condition, the identified data integration map indicating the presence or absence of a pathological condition.

The methods of the invention for predicting the behavior of a biochemical system can be applied to diagnosing and prognosing a pathological condition of an individual. An individual who has a disease or is in early stages of developing a disease has changes in characteristics of components of a biochemical system, such as changes in expression of molecules in a cell and changes in physical interactions between molecules in a cell. Changes in characteristics of system components can reflect a disease state or a predisposition to developing a disease. Monitoring a biochemical system by generating a data integration map can thus be used to correlate a condition of a biochemical system with the presence or absence of disease. A data integration map produced from a specimen obtained from an individual is a view of the physiological state of the individual. To identify a physiological state of an indicidual known or suspected of having a pathological condition, data integration map produced from a specimen derived from the individual suspected of having a pathological condition can be compared with data integration maps representing normal, pre-pathological, pathological states of various stage or severity, and post-pathological conditions to identify a data integration map describing biochemical system characteristics similar to those of the individual's specimen. A data integration map from a specimen of an individual is useful in prognostic applications, including determining the prognosis of an individual who has a disease or selecting a therapy that is tailored to the physiological or genetic state of the individual.

The methods of the invention for diagnosing and prognosing a pathological condition involve comparing a data integration map of a biochemical system for an individual suspected of having a pathological condition to a data integration map of a biochemical system produced from an individual exhibiting a known condition. A known condition can be, for example, a normal, pathological, prognostic or predetermination condition of the biochemical system or constituent system. Comparison of a data integration map of a suspected pathological specimen with one or more known conditions is useful for identifying, for example, a pre-pathological or pathological condition of the specimen. Such comparisons can also be used to characterize the stage of a particular pathological condition in a specimen. For example, a data integration map of a suspected or determined pathological specimen can be compared with data integration maps of specimens obtained at various representative stages of disease. Representative stages of different pathologies are well known in the art and are used for prognostic applications. For example, stages of cancer and tumor progression have been classified for a variety of different cancers and malignancies into stages of severity useful for prognosing survival and selecting course of therapy. Those skilled in the art will be able to select specimens representative of stages of particular diseases, including pre-pathological stages, pathological stages, and recovery or remission stages. Therefore, a data integration map produced from an individual suspected of having a pathological condition can be compared a data integration map generated from one or more types of biochemical systems, such as normal, pathological, prognostic or predetermination biochemical systems.

In addition, specimens can be obtained from an individual having or suspected of having a pathological condition over a period of time, such as during the course of disease or therapeutic treatment. By comparing data integration maps from specimens obtained over a period of time to one or more reference data integration maps, the rate of progression or recovery of disease can be determined.

Since a data integration map can describe substantially all of the components of a biochemical system, comparisons of data integration maps of normal and pathological conditions of a specimen can additionally be used to identify the biochemical networks altered by a pathological condition. Simlarly, identification of components or networks that are altered from a pathological state to a recovery state can be used to identify both the cellular function of the network and specific changes in components involved in the process of recovery. In addition to providing prognostic data this information is also applicable to selection of targets for drug development.

A reference data integration map can produced, for example, from a specimen having normal, pathological, prognostic or predetermination conditions of biochemical systems of the same histological type as the specimen used for producing a data integration map from an individual. A specimen used for producing a reference data integration map can be obtained from the individual known or suspected of having a pathological condition, from another individual, or from a group of individuals. For example, reference data integration maps can be produced from specimens obtained from one or more individuals and data elements can be averaged to produce an aggegrate reference data integration map.

The methods of the invention for diagnosing or prognosing a pathological condition involve identifying a data integration map representing the known condition that is substantially the same as the data integration map for the individual suspected of having a pathological condition. Two or more data integration maps can be generated and compared, or a comparative data integration map can be generated. A comparative data integration map will represent the changes of a biochemical system of an individual compared to a reference biochemical system. A data integration map that represents substantially all system components can be particularly useful for discriminating between biochemical systems having similar perturbation states. Thus, a data integration map can contain more than two, three, four, five, six, seven, eight or nine networks. Differences between a reference data integration map and a data integration map produced from an individual known or suspected of having a disease can be few or many. Therefore, changes in any number of value sets, such as, for example, more than two, three, four, five, six, seven, eight or nine value sets can be used to characterize a normal, pathological, predisposition, prognostic, or other perturbed biochemical system.

The methods of the invention for diagnosing and prognosing a pathological condition involve comparing two or more data integration maps. Such comparisons are described herein, in reference to the methods of predicting the behavior of a biochemical system. Comparisons between data integration maps involve comparing data elements, or a subset of data elements, for each component of a biochemical or constituent system. Two or more data integration maps having differences between 10% or fewer data elements are data integration maps which are substantially the same.

The compounds of the invention for restoring a perturbation state of a biochemical system can be used to restore a perturbation state of a biochemical system or constituate system of an individual having a pathological condition characterized by a perturbation state of a biochemical system. The method consists of administering an effective amount of one or more compounds that restore a perturbation state of a biochemical system to an individual having a perturbation state of a biochemical system.

As described in reference to the methods of diagnosing and prognosing a pathological condition, a data integration map prepared from a specimen obtained from an individual having a pathological condition can be compared to a reference data integration map, such as that from a normal or non-diseased specimen. The methods of the invention for restoring a perturbation state of a biochemical system involve administering an effective amount of a compound that restores a perturbation state of a biochemical system. Such a compound can be identified using methods known in the art or the methods described above, for example.

For treating or reducing the severity of a pathological condition a compound that restores a perturbation state to a biochemical system can be formulated and administered in a manner and in an amount appropriate for the condition to be treated; the weight, gender, age and health of the individual; the biochemical nature, bioactivity, bioavailability and side effects of the particular compound; and in a manner compatible with concurrent treatment regimens. An appropriate amount and formulation for a particular therapeutic application in humans can be extrapolated based on the activity of the compound in recognized animal models of the particular disorder.

The total amount of a compound that restores a perturbation state of a biochemical system can be administered as a single dose or by infusion over a relatively short period of time, or can be administered in multiple doses administered over a more prolonged period of time. Additionally, a compound can be administered in a slow-release matrix, which can be implanted for systemic delivery at or near the site of the target tissue.

A compound that restores a perturbation state of a biochemical system can be administered to an individual using a variety of methods known in the art including, for example, intravenously, intramuscularly, subcutaneously, intraorbitally, intracapsularly, intraperitoneally, intracisternally, intra-articularly, intracerebrally, orally, intravaginally, rectally, topically, intranasally, or transdermally.

A compound that restores a perturbation state of a biochemical system can be administered to a subject as a pharmaceutical composition comprising the compound and a pharmaceutically acceptable carrier. The choice of pharmaceutically acceptable carrier depends on the route of administration of the compound and on its particular physical and chemical characteristics. Pharmaceutically acceptable carriers are well known in the art and include sterile aqueous solvents such as physiologically buffered saline, and other solvents or vehicles such as glycols, glycerol, oils such as olive oil and injectable organic esters. A pharmaceutically acceptable carrier can further contain physiologically acceptable compounds that stabilize the compound, increase its solubility, or increase its absorption. Such physiologically acceptable compounds include carbohydrates such as glucose, sucrose or dextrans; antioxidants, such as ascorbic acid or glutathione; chelating agents; and low molecular weight proteins.

In addition, a formulation of a compound that restores a perturbation state of a biochemical system can be incorporated into biodegradable polymers allowing for sustained release of the compound, the polymers being implanted in the vicinity of where drug delivery is desired, for example, at the site of a tumor or implanted so that the compound is released systemically over time. Osmotic minipumps also can be used to provide controlled delivery of specific concentrations of a compound through cannulae to the site of interest, such as directly into a tumor growth or other site of a pathology involving a perturbation state. The biodegradable polymers and their use are described, for example, in detail in Brem et al., J. Neurosurg. 74:441-446 (1991).

To produce a data integration map from an individual suspected of having a pathological condition, a specimen is obtained from the individual that is representative of the pathological biochemical system of the individual. A specimen can be obtained from an individual as a fluid or tissue specimen. A fluid specimen can be blood, urine, saliva or other bodily fluids. A fluid specimen is particularly useful in methods of the invention since fluid specimens are readily obtained from an individual. Methods for collection of specimens are well known to those skilled in the art (see, for example, Young and Hermes, in Tietz Textbook of Clinical Chemistry, 3^{rd} ed., Burtis and Ashwood, eds., W. B. Saunders, Philadelphia, Chapter 2, pp. 42-72 (1999)).

If desired, a specimen can be processed under conditions that increase the availability of the molecules in the specimen for detection using analytical methods, such as those disclosed herein. For example, the specimen can be incubated in buffers and under conditions useful for preserving nucleic acids and polypeptides, and for detecting hybridization between nucleic acid molecules. Such conditions are well known to those skilled in the art (Sambrook et al., Molecular Cloning: A Laboratory Manual, 2^{nd} ed., Cold Spring Harbor Press, Plainsview, N.Y. (1989); Ausubel et al., Current Protocols in Molecular Biology (Supplement 47), John Wiley & Sons, New York (1999)). In addition, a specimen containing mRNA can be converted to cDNA, if desired, using reverse transcriptase.

A specimen can also be processed to eliminate or minimize the presence of interfering substances. For example, a specimen containing nucleic acids can be fractionated or extracted to remove potentially interfering non-nucleic acid molecules. The specimen can also be treated to decrease interfering nucleic acids, for example, by treating a specimen with DNAse or RNAse to increase the ability to detect RNA or DNA, respectively. Various methods useful for fractionating a fluid specimen or cell extract are well known to those skilled in the art, including subcellular fractionation or chromatographic techniques such as ion exchange, hydrophobic and reverse phase, size exclusion, affinity chromatography, and the like (Ausubel et al., supra, 1999; Scopes, Protein Purification: Principles and Practice, third edition, Springer-Verlag, New York (1993)).

The methods of the invention for predicting the behavior of a biochemical system involve measuring a characteristic of a biochemical system, constituent system or system component. One characteristic that can be conveniently measured is gene expression level of a biochemical system component. A change in gene expression can be measured, for example, by detecting the amount of mRNA encoded by a gene or the amount of polypeptide corresponding to a given amino acid sequence encoded by a gene.

The methods of the invention involve measuring changes in gene expression by detecting the amount of mRNA or polypeptide present in a sample. Methods for measuring both mRNA and polypeptide quantity are well known in the art. The methods for measuring mRNA typically involve detecting nucleic acid molecules by specific hybridization with a complementary probe in solution or solid phase formats. Such methods include northern blots, polymerase chain reaction after reverse transcription of RNA (RT-PCR), and nuclease protection. Measurement of a response of a pathway component can be performed using global gene expression methods. Global gene expression methods can be used advantageously to measure a large population of system components including essentially all of the expressed genes of an organism or cell. Examples of methods well known in the art applicable to measuring a change in expression of a population of genes include cDNA sequencing, clone hybridization, differential display, subtractive hybridization, cDNA fragment fingerprinting serial analysis of gene expression (SAGE), and DNA microarrays. These methods are useful, for example, for identifying differences in gene expression under different conditions of a biochemical system. Methods of detecting changes in gene expression can be performed both qualitatively or quantitatively.

As disclosed herein, a useful method of monitoring gene expression is hybridization of sample mRNA to a DNA microarray. A DNA microarray is a useful tool for study of a biochemical system because the sequences of specific oligonucleotides or cDNAs that represent each system component are generally located at specific physical sites on the microarray. In addition, the relative concentration of a given transcript in two different samples can be readily determined. A variety of methods can be used for labeling samples for measurements of gene expression using a DNA microarray method. For example, mRNA can be labeled directly, such as by using a psoralen-biotin derivative or by ligation to an RNA molecule carrying biotin, or labeled nucleotides can be incorporated into cDNA during or after reverse transcription of polyadenylated RNA, or cDNA having a T7 promoter at the 5′ end can be generated and used as a template for a reverse transcription reaction in which labeled nucleotides are incorporated into cDNA. Commonly used labels include the fluorophores fluorescein, Cy3, and Cy5, and non-fluorescent biotin, which can be subsequently labeled by staining with a fluorescent streptavidin conjugate. The use of Cy3 and Cy5 is shown in Example II, which describes a two-color hybridization strategy commonly used with DNA microarrays.

A variety of methods well known in the art can be used to monitor protein levels either directly or indirectly. Such methods include western blotting, two-dimensional gels, methods based on protein or peptide chromatographic separation, methods that use protein-fusion reporter constructs and calorimetric readouts, methods based on characterization of actively translated polysomal mRNA, and mass spectrometric detection.

One convenient method for determining expression levels of molecules is to use a direct quantitation method such as the isotope-coded affinity tag (ICAT) method (Gygi et al., Nature Biotechnol. 17:994-999 (1999)). The ICAT method involved the comparison of a test sample and reference sample which are differentially labeled with isotopes that can be distinguished using mass spectrometry, as described in more detail below. In addition to using an ICAT reagent that modifies polypeptides or fragments thereof having particular amino acids, polypeptide profiles, for example, a peptide map of a polypeptide where the peptides can be correlated with the polypeptide. Use of a peptide map to correlate with a polypeptide expression level can be used to obviate the labeling required for using the ICAT method, if desired.

In determining a change in expression of a component, it can be advantageous to measure both mRNA and polypeptide levels of the component because a difference in an mRNA expression level in response to a perturbation may not correspond to the difference in polypeptide expression level due to post-translational modifications. As described herein, in Examples II and IV, measurement of both mRNA and polypeptide expression levels is useful for identifying perturbation-induced changes in component expression that are not detectable using either mRNA or polypeptide expression measurement alone. However, it is not necessary that component expression levels be monitored by measuring both mRNA and polypeptide expression levels. Correlative changes between other characteristics of components of a biochemical system can also reveal changes in component behaviors that are not detectable using another method.

A change in expression of a component can be measured using a variety of methods, as described above. Components that are homologous generally have segments of high sequence identity in mRNA and polypeptide sequence. Components sharing a high degree of similarity can be indistinguishable by certain methods of mRNA or polypeptide analysis. As described in Example II, homologous genes that cannot be distinguished based on mRNA expression profiles can be distinguished at the protein level using the ICAT technique. A variety of methods known in the art can be applied to determining a change in expression of components that are homologous to each other. Such methods include the methods described herein and other well-known techniques such as, for example, oligonucleotide assays and two dimensional protein gels. These methods can similarly be applied if the change in expression of a component which is expressed at particularly low or high levels cannot be measured accurately by a particular technique due to low signal-to-noise ratio or saturation of the detection method. Thus, a change in expression or activity of a component can be determined using a variety of techniques, either independently of each other, or in combination.

The methods of the invention for predicting the behavior of a biochemical system involve determining a change in expression or activity of a candidate network component. As described herein, the change in expression or activity of a population of components can be monitored using a variety of global gene expression analysis methods, such as DNA microarrays. The use of global analysis methods can result in identifying a large number of candidate network components. To identify common patterns of expression among genes, and to reduce the number of distinct expression profiles under consideration, a set of significantly-effected genes can be divided into clusters using manual examination of the data or by using statistical methods. Statistical methods useful for clustering having similar expression ratios over all perturbations include, for example, self-organizing maps, K-tuple means clustering and hierarchical clustering. Genes that have similar patterns of expression in a series of perturbations can be functionally related, as shown in Example II, which describes the clustering of the enzymes involved in galactose utilization based on similar expression patterns across a series of 20 perturbations. As described below, a physical interaction map can be advantageously used to suggest or identify cellular functions of such clustered genes.

Physical interactions between one or more system components can be determined experimentally, or obtained from the literature and public or private databases. Methods useful for identifying physical protein-protein and protein-nucleic acid interactions are well known in the art and include, for example, biochemical methods such as co-purification, co-immunoprecipitation, the yeast two-hybrid method, and phage display methods. Those skilled in the art will know how to search the literature and databases to identify components and candidate components of their pathway of interest. Similarly, those skilled in the art will know how to perform experiments most appropriate for the organism or cell under study to identify polypeptides, nucleic acids, or other molecules that interact with a pathway component.

The methods of the invention involve the measurement of a change in expression of a system component. A direct quantitation method useful for determining the level of expression of a molecule in a sample, as demonstrated in Example II, is the isotope-coded affinity tag (ICAT) method (Gygi et al., Nature Biotechnol. 17:994-999 (1999) which is incorporated herein by reference). The ICAT method uses an affinity tag that can be differentially labeled with an isotope that is readily distinguished using mass spectrometry, for example, hydrogen and deuterium. The ICAT affinity reagent consists of three elements, an affinity tag, a linker and a reactive group.

One element of the ICAT affinity reagent is an affinity tag that allows isolation of peptides coupled to the affinity reagent by binding to a cognate binding partner of the affinity tag. A particularly useful affinity tag is biotin, which binds with high affinity to its cognate binding partner avidin, or related molecules such as streptavidin, and is therefore stable to further biochemical manipulations. Any affinity tag can be used so long as it provides sufficient binding affinity to its cognate binding partner to allow isolation of peptides coupled to the ICAT affinity reagent.

A second element of the ICAT affinity reagent is a linker that can incorporate a stable isotope. The linker has a sufficient length to allow the reactive group to bind to a sample polypeptide and the affinity tag to bind to its cognate binding partner. The linker also has an appropriate composition to allow incorporation of a stable isotope at one or more atoms. A particularly useful stable isotope pair is hydrogen and deuterium, which can be readily distinguished using mass spectrometry as light and heavy forms, respectively. Any of a number of isotopic atoms can be incorporated into the linker so long as the heavy and light forms can be distinguished using mass spectrometry. Exemplary linkers include the 4,7,10-Trixie-1,13-tridecanediamine based linker and its related deuterated form, 2,2′,3,3′,11,11′,12,12′-octadeutero-4,7,10-Trixie-1,13-tri decanediamine, described by Gygi et al. (supra, 1999). One skilled in the art can readily determine any of a number of appropriate linkers useful in an ICAT affinity reagent that satisfy the above-described criteria.

The third element of the ICAT affinity reagent is a reactive group, which can be covalently coupled to a polypeptide in a sample. Any of a variety of reactive groups can be incorporated into an ICAT affinity reagent so long as the reactive group can be covalently coupled to a sample molecule. For example, a polypeptide can be coupled to the ICAT affinity reagent via a sulfhydryl reactive group, which can react with free sulfhydryls of cysteine or reduced cystines in a polypeptide. An exemplary sulfhydryl reactive group includes an iodoacetamido group, as described in Gygi et al. (supra, 1999). Other exemplary sulfhydryl reactive groups include maleimides, alkyl and aryl halides, -haloacyls and pyridyl disulfides. If desired, the sample polypeptides can be reduced prior to reacting with an ICAT affinity reagent, which is particularly useful when the ICAT affinity reagent contains a sulfhydryl reactive group.

A reactive group can also react with amines such as Lys, for example, imidoesters and N-hydroxysuccinimidyl esters. A reactive group can also react with carboxyl groups found in Asp or Glu, or the reactive group can react with other amino acids such as His, Tyr, Arg, and Met. Methods for modifying side chain amino acids in polypeptides are well known to those skilled in the art (see, for example, Glazer et al., Laboratory Techniques in Biochemistry and Molecular Biology: Chemical Modification of Proteins, Chapter 3, pp. 68-120, Elsevier Biomedical Press, New York (1975); Pierce Catalog (1994), Pierce, Rockford IL). One skilled in the art can readily determine conditions for modifying sample molecules by using various reagents, incubation conditions and time of incubation to obtain conditions optimal for modification of sample molecule for use in methods of the invention.

The ICAT method is based on derivatizing a sample molecule such as a polypeptide with an ICAT affinity reagent. A control reference sample and a sample from an individual to be tested are differentially labeled with the light and heavy forms of the ICAT affinity reagent. The derivatized samples are combined and the derivatized molecules cleaved to generate fragments. For example, a polypeptide molecule can be enzymatically cleaved with one or more proteases into peptide fragments. Exemplary proteases useful for cleaving polypeptides include trypsin, chymotrypsin, pepsin, papain, Staphylococcus aureus (V8) protease, and the like. Polypeptides can also be cleaved chemically, for example, using CNBr or other chemical reagents.

Once cleaved into fragments, the tagged fragments derivatized with the ICAT affinity reagent are isolated via the affinity tag, for example, biotinylated fragments can be isolated by binding to avidin in a solid phase or chromatographic format. If desired, the isolated, tagged fragments can be further fractionated using one or more alternative separation techniques, including ion exchange, reverse phase, size exclusion affinity chromatography and the like. For example, the isolated, tagged fragments can be fractionated by high performance liquid chromatography (HPLC), including microcapillary HPLC.

The fragments are analyzed using mass spectrometry (MS). Because the sample molecules are differentially labeled with light and heavy affinity tags, the peptide fragments can be distinguished on MS, allowing a side-by-side comparison of the relative amounts of each peptide fragment from the control reference and test samples. If desired, MS can also be used to sequence the corresponding labeled peptides, allowing identification of molecules corresponding to the tagged peptide fragments.

An advantage of the ICAT method is that the pair of peptides tagged with light and heavy ICAT reagents are chemically identical and therefore serve as mutual internal standards for accurate quantification (Gygi et al., supra, 1999). Using MS, the ratios between the intensities of the lower and upper mass components of pairs of heavy- and light-tagged fragments provides an accurate measure of the relative abundance of the peptide fragments. Furthermore, a short sequence of contiguous amino acids, for example, 5-25 residues, contains sufficient information to identify the unique polypeptide from which the peptide fragment was derived (Gygi et al., supra, 1999). Thus, the ICAT method can be conveniently used to identify differentially expressed molecules, if desired.

The control reference sample can also be a pool of reference samples. For example, the control reference sample can be a pool of two or more samples of reference individuals used to establish an unperturbed reference sample, if desired. Such a pool of all reference individuals is expected to result in a reference level that is essentially an average of the reference individuals. One skilled in the art can readily determine a desired number of one or more reference individuals, including all reference individuals, to include in a pool for use as a control reference sample. The amount of a pooled sample is adjusted accordingly to allow direct comparison to the perturbation state test sample, for example, based on cell number, amount of protein, or some other appropriate measure of the relative amount of control reference sample and test sample.

The above-described ICAT method can be performed as tandem MS/MS. A dual mode of MS can be performed in which MS alternates in successive scans between measuring relative quantities of peptides and recording of sequence information of selected peptides (Gygi et al., supra, 1999). Other modes of MS include matrix-assisted laser desorption-time of flight (MALDI-TOF), an electrospray process with MS, and ion trap. In ion trap MS, fragments are ionized by electrospray and then put into an ion trap. Trapped ions can then be separately analyzed by MS upon selective release from the ion trap. Fragments can also be generated in the ion trap and analyzed.

In addition to polypeptides, the ICAT method can similarly be applied to determining the expression level of nucleic acid molecules. In such a case, the ICAT affinity reagent incorporates a reactive group for a nucleotide, for example, a group reactive with an amino group. The ICAT affinity reagent can incorporate functional groups specific for a particular nucleotide or a nucleotide sequence of 2 or more nucleotides. The nucleic acid molecules can be cleaved enzymatically, for example, using one or more restriction enzymes, or chemically (see Sambrook et al., supra, 1989; Ausubel et al., supra, 1999).

The methods of the invention for detecting nucleic acids and/or polypeptides, particularly methods useful for detecting large numbers of molecules such as microarray-based methods, can be combined with well known methods of detecting expression levels of small molecules to determine the expression levels of more than one type of molecule. Exemplary methods of determining the levels of small molecules include the use of enzyme-based assays, including calorimetric and radioenzymatic (incorporation of radioactive substrates), chromogenic assays, spectrophotometry, fluorescence spectroscopy, liquid chromatography, including ion exchange, affinity, HPLC, paper chromatography, gas chromatography, photometry atomic absorption spectrometry, emission spectroscopy, including inductively coupled plasma emission spectroscopy, mass spectrometry, inductively coupled mass spectrometry, neutron activation analysis, X-ray fluorescence spectrometry, electrochemical techniques such as anodic stripping voltametry, polarographic techniques, flame emission spectrophotometry, electrochemical methods such as ion selective electrodes, chemical titration, and the like (Tietz Textbook of Clinical Chemistry, second edition, Burtis and Ashwood, eds., W. B. Saunders Company, Philadelphia (1994); Tietz Textbook of Clinical Chemistry, 3rd ed., Burtis and Ashwood, eds., W. B. Saunders Co., Philadelphia (1999)). Small molecule assay methods can also be adapted to accommodate multiple samples, including solid phase or microarray based formats.

The methods of the invention involve measuring the expression or activity of a component in a sample. A sample can be isolated from a variety of sources. For example, a sample can be prepared from any biological fluid, cell, tissue, organ or portion thereof, or species. A sample can be obtained or derived from the individual. For example, a sample can be a histologic section of a specimen obtained by biopsy, or cells that are placed in or adapted to tissue culture. A sample further can be a subcellular fraction or extract, such as, for example, a nuclear or cytoplasmic cellular fraction. A sample can also be a isolated preparation of nucleic acid or polypeptide. A sample can be prepared by methods known in the art suitable for the particular methods used for measuring the expression or activity of a component, such as the methods described herein. Those skilled in the art will know how to prepare a sample for use with the selected analytical methods for measuring nucleic acids, polypeptides, and other biological molecules.

Methods for determining the levels of other biological molecules are well known to those skilled in the art. For example, methods of analyzing small molecules such as glucose, sugars, carbohydrates, calcium, amino acids, lipids, neurotransmitters, as well as other small molecules disclosed herein, can be analyzed using well known clinical chemistry methods (see, for example, Tietz Textbook of Clinical Chemistry, 3rd edition, Burtis and Ashwood, eds., W. B Saunders Company, Philadelphia (1999)).

The methods of the invention can be applied to small samples such as cells removed from a particular tissue or tumor. Methods well known in the art for amplification of mRNA, such as, for example, PCR-based amplification and template-directed in vitro transcription(IVT) can be used for generating a sample to be used in the methods of the invention. Methods of amplifying nucleic acids by reverse transcription are well known to those skilled in the art (see, for example, Dieffenbach and Dveksler, PCR Primer: A Laboratory Manual, Cold Spring Harbor Press (1995)).

The methods of the invention can be performed using semi-automated or automated formats. Those skilled in the art will know how to automate steps of sample preparation and data analysis, including automated generation and updating of a data integration map and physical interaction map. A data integration map or physical interaction map can be presented in the form of a web-based tool for analysis and discovery of biochemical system and system component function, and can serve as a reference map useful for web-wide comparative studies.

It is understood that modifications which do not substantially affect the activity of the various embodiments of this invention are also included within the definition of the invention provided herein. Accordingly, the following examples are intended to illustrate but not limit the present invention.

### EXAMPLE I

### Model of Galactose Utilization in Yeast

This example shows a model of galactose utilization in the yeast Saccharomyces cerevisiae.

The process of galactose utilization in the yeast Saccharomyces cerevisiae was examined using a systematic approach. Galactose utilization is a classic example of a genetic regulatory switch, in which the enzymes required specifically for import and catalysis of galactose sugar are active only in the presence of galactose and in the absence of repressing sugars such as glucose. Extensive biochemical studies and saturating mutant screens have defined the genes, gene products, and metabolic substrates required for function of this process and have elucidated the key molecular interactions between these components that lead to pathway activation or inhibition.

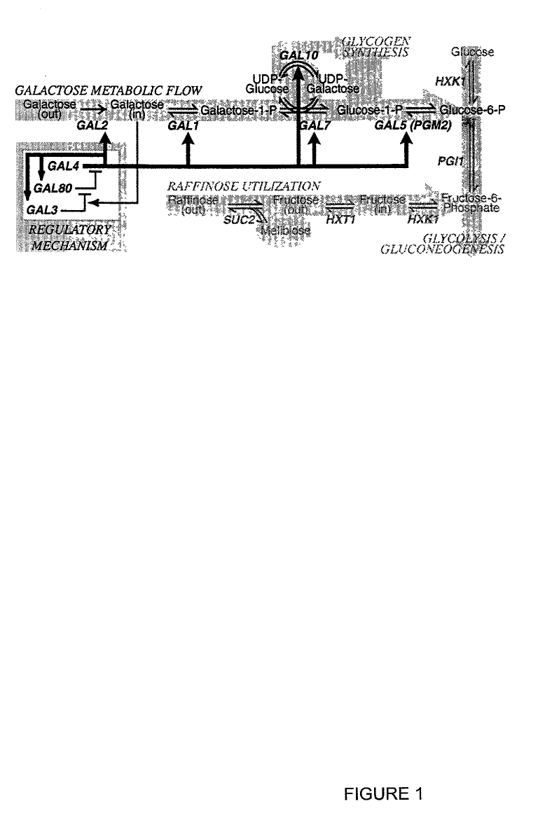

Galactose utilization is relatively specialized, compact, and well-understood (see Lohr et al., Faseb Journal 9: 777-787 (1995) and Johnston and Carlson Regulation of Carbon and Phosphate Utilization (eds. Jones, E. et al., Cold Spring Harbor Laboratory Press, Cold Spring Harbor, (1992), for recent reviews). Galactose utilization consists of a biochemical pathway that results in the conversion of galactose into glucose-6-phosphate, which is subsequently metabolized in glycolysis, and a regulatory mechanism that functions to determine whether the pathway is on or off, as shown in FIG. 1.

FIG. 1 illustrates a model of galactose utilization. Yeast cells acquire and convert galactose sugar into glucose-6-P through a series of steps involving the GAL2 transporter gene and the enzymes produced by the GAL1, 5, 7, and 10 genes. These genes are transcriptionally regulated by a control mechanism consisting primarily of GAL4, 80, and 3. GAL6 produces an additional regulatory factor involved in repression of the GAL enzymes. In addition to galactose metabolic flow and the associated control mechanism, the figure shows the relationship of galactose utilization to raffinose, glucose, and glycogen metabolism.

Galactose utilization involves at least three types of proteins. A single transporter gene (GAL2) encodes a permease which moves galactose across the cellular membrane and into the cell. A group of enzymatic genes produces the proteins required for conversion of intracellular galactose, including galactokinase (GAL1), uridylyltransferase (GAL7), epimerase (GAL10), and phosphoglucomutase (GAL5/PGM2). The regulatory genes GAL3, GAL4, and GAL80 exert tight transcriptional control over the transporter, the enzymes, and, to a certain extent, each other. GAL4p is a DNA-binding factor that can strongly activate transcription, but in the absence of galactose, GAL80p binds GAL4p and inhibits its activity. When galactose is present in the cell, it interacts with GAL3p, which in turn binds to the GAL80p:GAL4p complex. This contact causes GAL80p to release its repression of GAL4p, so that the transporter and enzymes are expressed at a high level.

The current model of galactose utilization provides relatively little indication of the interactions between GAL genes and genes involved with other cellular processes. Several studies link GAL5 to calcium uptake, indicate that mitochondrial function may be required for GAL-gene induction, and suggest that galactose, like glucose, may repress genes involved in utilization of alternative energy sources (i.e. catabolite repression); however, the precise relationships underlying these observations are not well defined. Also, a few genes involved in other cellular processes appear to regulate GAL-gene transcription, such as, for example, GAL6/LAP3. Although GAL6 functions predominantly in a drug-resistance pathway, it can also suppress transcription of the GAL transporter and enzymes by 2- to 5-fold through a DNA binding interaction and may itself be transcriptionally controlled by GAL 4.

Thus, the components involved in the biochemical and regulatory pathways that affect galactose utilization in the yeast Saccaromyes cerevisiae have been well-studied. Although the components in the biochemical and regulatory pathways have been identified, components involved in the global cellular changes that are affected during galactose utilization are less well understood. As described below, the methods of the invention were used to identify components of the biochemical networks that affects galactose utilization in Saccaromyes cerevisiae.

### EXAMPLE II

### Perturbation of Galactose Utilization and Measurement of Global Chances in Expression

This example shows a set of twenty genetic and environmental perturbations to the yeast galactose-utilization pathway and the resulting global changes in mRNA and polypeptide expression.

Perturbation of Galactose Utilization

A set of twenty initial genetic and environmental perturbations to the yeast galactose-utilization pathway was performed. Wild type (wt) and nine genetically-altered yeast strains were examined, each with a complete deletion of one of the nine GAL genes: transport (gal266 ), enzymatic (gal1Δ, 5Δ, 7Δ, or 10Δ), or regulatory (gal3Δ, 4Δ, 6Δ, or 80Δ). All strains were perturbed environmentally by steady-state growth in the presence (+gal) or absence (−gal) of 2% galactose. Since all deletion strains except for gal80Δ and gal6Δ are deficient in galactose utilization, 2% raffinose was also provided in both media. Raffinose is not a repressing carbon source and therefore does not have a large effect on GAL gene expression.

Yeast srains were derived from the wild type haploid MATa strain BY4741 (ATCC # 201388, MATa his3Δ1 leu2Δ0 met15Δ0 ura3Δ0). The mutants gal1Δ, 3Δ, 5Δ, 7Δ, and 10Δ were constructed by complete replacement of these genes with kanR using the loxP-kanR-loxP cassette (Guldener et al., Nucleic Acids Res., 24:2519-2524, (1996)) while gal2Δ, 4Δ, 6Δ, and 80Δ were obtained from the Saccharomyces Genome Deletion Project (Winzeler et al., Science, 285:901-906, (1999)) and were constructed analogously. To confirm effects of the gal10 mutant in galactose, the strains #R4146 (gal1Δ gal10Δ) and YM366 (MATa ura3-52 his3Δ 200 ade2-101lys2-801 tyrl gal10Δ 120, generous donation from Mark Johnston) were also used. Because expression of the heterologous, constitutively-active kanR gene can have significant effects on yeast gene expression, two control strains having kanR inserted in non-coding regions of chromosomes 2 and 10, respectively, were created. Gene expression levels for either strain did not differ significantly from those of congenic yeast lacking kanR, as measured with our whole-yeast genome microarray.

In summary, yeast strains containing deletions of each of the well-characterized genes of the biochemical and regulatory pathways of galactose utilization were generated.

Global Changes in mRNA Expression

Global changes in mRNA expression resulting from each perturbation were examined using DNA microarrays of approximately 6200 nuclear yeast genes, representing 97% of the yeast genome. Yeast were inoculated in 100 ml of either GAL-inducing “+gal” media (1% yeast extract, 2% peptone, 2% raffinose, 2% galactose) or non-inducing “−gal” media (1% yeast extract, 2% peptone, 2% raffinose). Cultures are grown overnight at 30° C. to a density of 1-2 OD₆₀₀, washed in 5 ml H₂O, and snap-frozen on dry ice. In each experiment, mRNA from a perturbed strain was reverse-transcribed into cDNA, labeled with a fluorescent dye, combined with a cDNA reference sample, and hybridized to a microarray. The cDNA reference sample was derived from wild type yeast grown in +gal media and labeled using a different dye. After hybridization, a confocal scanning device measured the fluorescence intensity corresponding to each gene spotted on the microarray, separately for each of the two dyes.

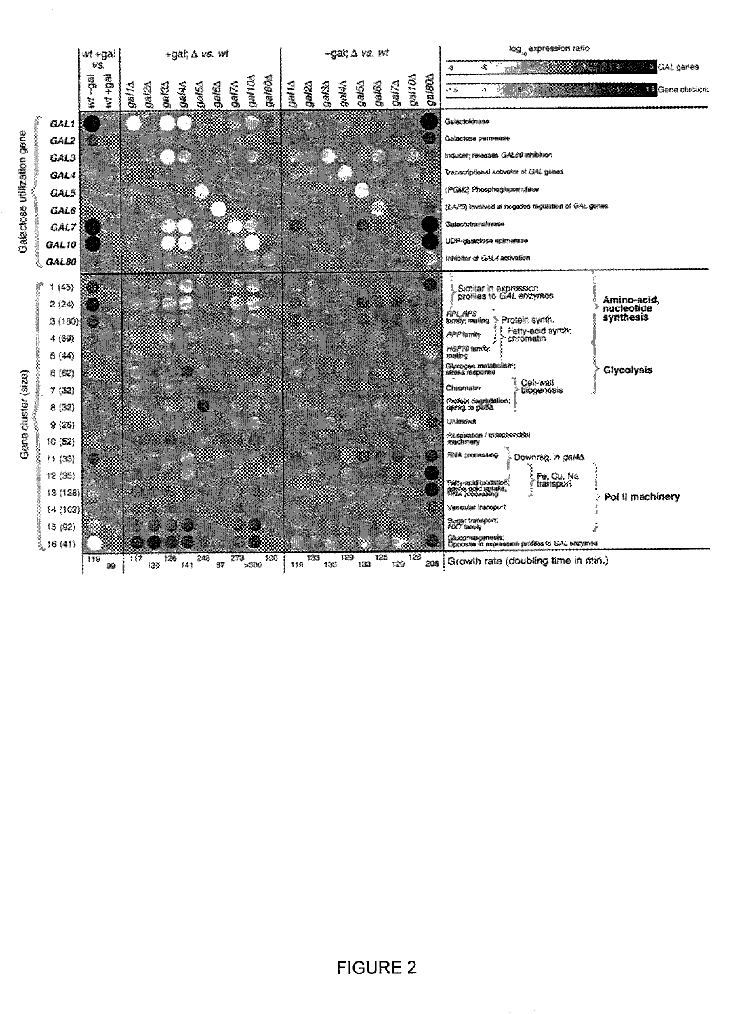

FIG. 2 shows a perturbation matrix summarizing the salient effects of each perturbation on mRNA-expression of the GAL genes and gene clusters and the cellular growth rate in each perturbation as measured prior to harvest. DNA microarrays were used to measure the mRNA-expression profile of yeast cells undergoing long-term, steady-state growth (1-2 OD₆₀₀) in the presence of each of 20 genetic or environmental perturbations to the galactose-utilization pathway. Each spot in the matrix represents the change in expression level of a gene (first nine rows) or gene cluster (remaining 16 rows) due to a particular perturbation (listed above each column), with medium gray representing no change, darker or lighter shades representing increased or reduced amounts of expression respectively, and spot size scaling with the magnitude of change. Clusters are represented by the average change in expression level of the genes they contain and are annotated where possible with the predominant known function(s) of those genes. Because the average profiles show less absolute change than do the individual GAL genes, the intensity scale is reduced for display of cluster data (see scale at upper right). Measured growth rates in each perturbation condition appear below each column. Close examination of the genes in each cluster suggests good qualitative correspondence with specific cellular processes or functions. Thus, many clusters are annotated in FIG. 2 with descriptive labels summarizing the predominant functions of the genes they contain.

In order to separate the effects of gene deletion from the effects of environmental perturbation, the matrix shows expression-level changes resulting from each gene deletion in relation to the wild type state, holding the environmental conditions constant. Thus, for gene deletions in the absence of galactose (right half of FIG. 2), expression levels are relative to those of a wild type strain also grown without galactose (wt−gal); in all other cases expression levels are shown relative to wt+gal. One of the environmental perturbations is identical to the reference condition (wt+gal vs. wt+gal, second column from left); this perturbation represents a “negative control” with no significant effects on expression level for any gene

In each perturbation, four expression-level samples for each gene were obtained over two hybridizations to yeast microarrays containing two replicate spots per gene. In the first hybridization, RNA from the perturbed cell population was labeled with Cy3 while RNA from the reference population (wt+gal) was labeled with Cy5; in the second hybridization, the reverse labeling scheme is used. Microarray images are processed with Dapple, a software tool for array spot finding and quantitation (University of Washington web site). Once spots are located in the image, an estimate of background intensity is subtracted from the median intensity within each spot area, separately for each spot and dye. These values are then normalized such that the medians of all Cy3 and all Cy5 intensities are equal. For FIGS. 2 and 5 only, deletion strains grown in −gal are displayed relative to wt−gal conditions by subtracting the log₁₀; expression ratio of wt−gal vs. reference from the log₁₀ expression ratio of the deletion strain vs. reference.

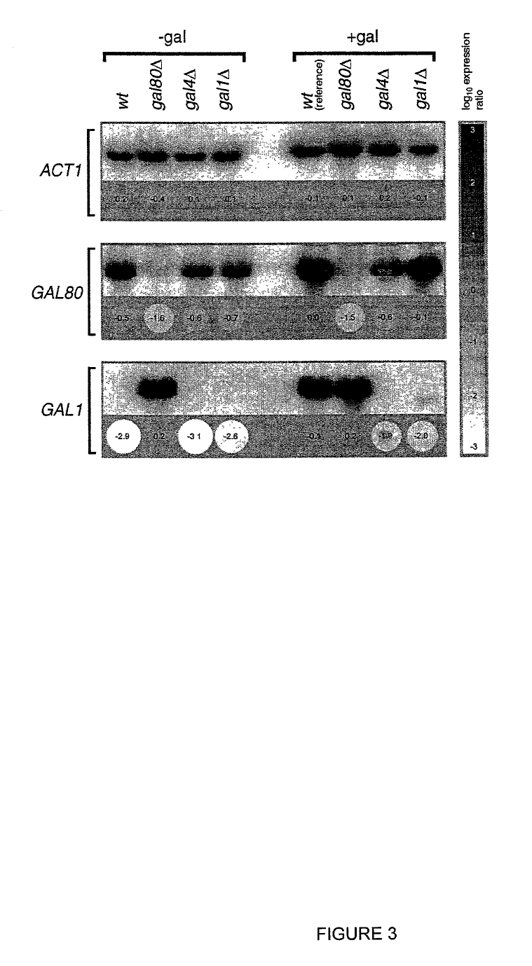

Expression ratios obtained for the genes GAL1, GAL80, and ACT1 by this procedure corresponded well with Northern blots of RNA derived from gal1Δ, gal4Δ, gal80Δ, and wild type yeast, grown in both +gal and −gal conditions (FIG. 3).

A set of 997 yeast genes having mRNA-expression levels that differed significantly from reference under one or more perturbations, was determined using a statistical approach based on maximum-likelihood estimation. Briefly, an error model is constructed to describe the additive and multiplicative errors in the background-subtracted, normalized intensity measurements, with model parameters tuned to best fit the variation observed in the four replicate intensities measured for each dye over each of ˜6200 genes. A likelihood statistic, λ, is computed for each gene to determine whether, under the model, intensities representing the perturbed and unperturbed expression levels are significantly different; genes having λ=45 were selected as differentially expressed. This value is approximately the maximum obtained in control experiments, also involving four samples per gene, in which the two mRNA populations compared are derived from identical strains and growth conditions (wt yeast in +gal media). Model parameters and likelihoods were estimated independently for each of the 20 conditions. Since the model parameters provide more accurate estimates of the mean intensities μ_{X} and μ_{y} for each sample than those obtained by taking the average of the four samples, these are used to compute an expression ratio log₁₀ (μₓ/μ_{y}) for each gene in each perturbation.

To identify common patterns of expression among these genes and to reduce the number of distinct expression profiles under consideration, the set of 997 affected genes was divided into 16 gene clusters using an algorithm based on self-organizing maps, where each cluster contains genes with similar expression ratios over all perturbations. The 997 affected genes were clustered based on Euclidean distance between their log₁₀ expression ratios over all perturbation conditions, using a 6 row by 4 column self-organizing map (SOM) implemented by the GeneCluster application (Gygi et al., Nat. Biotechnol. 17:994-999, (1999)). A 6×4 SOM produced tighter clusters and identified more distinct expression patterns than geometries involving fewer nodes, and fewer redundant expression patterns than geometries involving more nodes. In addition, the resulting clusters were similar in content to clusters produced by other algorithms such as k-means and appeared as fairly distinct, compact groups in an analysis of the first two principal components of the data. Clustering was run over 500 “epochs;” otherwise default parameters were used. Clusters that (a) were derived from neighboring SOM nodes, (b) had high correlation (ρ>0.8), and (c) contained genes of qualitatively similar function were combined to form a single cluster. Eight pairs were combined resulting in 16 clusters total. The galactose transporter (GAL2) and nearly all of the enzymes (GAL1, 7, 10) fell into cluster 1.

Measurement of Global Changes in Protein Expression Between wt+gal and wt−gal Environmental Perturbations

In order to characterize the cellular response to perturbation of the galactose-utilization pathway, global changes in protein expression between the wt+gal vs. wt−gal environmental perturbations were examined. According to the recently-described technique based on isotope-coded affinity tags (ICAT), whole-cell protein extracts from wt+gal and wt−gal cultures were prepared. Cells were grown and harvested as for mRNA measurement, and protein extract was prepared according to Futcher (Futcher et al., Mol. Cell. Biol., 19:7357-7368, (1999)). Extracts were desalted (Biorad Econo-Pac 10DG columns, Hercules, Calif.) in 50 mM Tris 8.3, 1 mM EDTA, 0.05% SDS. The ICAT method was applied to 300 μg of protein from each extract, with the following modifications (Gygi et al., Nat. Biotechnol., 17:994-999, (1999)). After trypsin digestion, the sample was diluted in Buffer A (5 mM KH₂PO₄ 25% CH₃CN) and the pH was adjusted to 3.0 with H3PO4. Peptides are fractionated by cation exchange HPLC (2.1×200 mm PolySULFOETHYL A, PolyLC Inc., Columbia, Md.) by running a gradient from 0 to 25% Buffer B (5 mM KH₂PO₄, pH 3, 350 mM KCl, 25% CH₃CN) over 30 min., followed by 25% to 100% Buffer B over 20 min. at 0.2 ml/min. Labeled peptides were affinity purified using monomeric avidin chromatography (Pierce, Rockford, Ill.) and washed with 2×PBS, pH 7.2, 1×PBS pH 7.2, and 50 mM NH₄HCO₃,pH 8.3, 20% CH₃OH. Peptides were eluted with 0.4% TFA in 30% CH₃CN. Ten to 80% of the peptide mixture was analyzed by LC/MS/MS.

Equal amounts of protein from each extract were labeled with heavy and light ICAT isotopes, respectively. The extracts were combined, trypsin-digested, and the resulting peptide mixture fractionated and purified in a series of chromatography steps. ICAT-labeled peptides were separated and analyzed by microcapillary liquid chromatography electrospray ionization tandem mass spectrometry (LC/MS/MS). Computational analysis of the resulting mass spectra identified peptides by their characteristic fragment ions and reported the relative abundances of their heavy and light ICAT isotopes: the ratio of these abundances provided an estimate of protein-expression ratio for the +/−gal growth conditions. Frequently, several identified peptides corresponded to the same protein, in which case average log₁₀ ratio of the multiple heavy vs. light abundance measurements was computed.

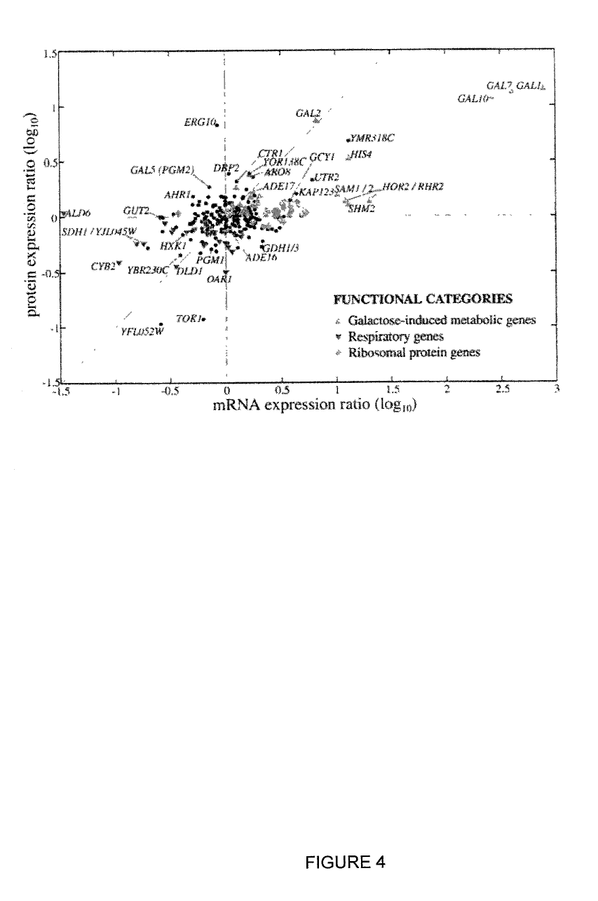

A set of 288 proteins and corresponding protein-expression ratios were identified using the ICAT technique. This set of proteins includes all of the GAL enzymes and the transporter. GAL regulatory genes were not detected. Approximately 30 genes displayed clear changes in protein-expression between the wt+gal and wt−gal conditions (absolute log₁₀ ratio>0.25), 15 of which had not changed in mRNA-expression level in response to any perturbation. In addition, 130 proteins corresponded to genes that were previously clustered according to mRNA-expression profile, with all clusters except cluster 9 represented by at least one protein measurement. FIG. 4 shows a scatter plot of the protein-expression ratios vs. the corresponding mRNA-expression ratios obtained with DNA microarrays: in general, protein-expression ratios correlate positively (ρ=0.61) and significantly (p=1.3×10⁻²⁰) with their mRNA counterparts. Ratios of wt+gal to wt−gal protein expression, measured for each of 288 genes using the ICAT technique, are plotted against the corresponding mRNA-expression ratios measured with the yeast-gengme microarray. Many genes with elevated mRNA or protein expression in wt+gal are metabolic (▴) or ribosomal (♦), while genes involved in respiration (▾) have reduced expression levels. Due to high sequence similarity, several groups of genes are indistinguishable by both the microarray and the ICAT assays; corresponding points on the scatter plot are annotated with the names of all indistinguishable genes separated by a slash.

In summary, nine components of the galactose utilization pathway in yeast were perturbed by gene deletion. The global response of system components to each pathway perturbation was examined by quantitative comparisons of mRNA expression and protein expression in the presence and absence of galactose. A set of 1013 candidate network components was identified and genes were grouped into clusters of genes with similar expression ratios over all perturbations.

### EXAMPLE III

### Integration of mRNA Response, Protein Response, and the Physical Interaction Network

This example shows the development of a physical interaction map representing the network of components involved in galactose utilization and the use of the physical interaction map for determining and predicting the functions of genes in the biochemical network.

For each of the 20 perturbation conditions, a determination of which mRNA- and protein-expression changes could be attributed to previously-known, underlying physical interactions in yeast was performed. Because the current model of galactose utilization primarily addresses interactions among the GAL genes, automated software for integrating this model with known physical interactions relevant to other biological processes was developed. First, a whole-yeast-cell, physical-interaction database was developed by synthesizing a list of 2710 protein-protein interactions, derived predominantly through yeast two-hybrid assays, combined with 317 protein DNA interactions present in either of two publicly available transcription factor databases, TRANSFAC (Wingender et al., Nucleic Acids Res., 28:316-319, (2000)) and SCPD (Zhu and Zhang, Bioinformatics, 15:607-611, (1999)).

A program based on Graph Win24 was then used to create and display the network of these physical interactions. The biochemical network was restricted to the set of 1013 genes that were affected by at least one perturbation (997 genes with changes in mRNA plus an additional 15 genes with changes in protein). Genes that did not change significantly in either mRNA- or protein-expression were added to the network only if they were involved in two or more physical interactions with genes in the 1013-gene set. This rule allowed automated detection of transcription factors which were not themselves affected but which regulated a large class of affected genes.

The resulting physical interaction network is shown in FIG. 5a and contains a total of 348 nodes and 362 interactions, where each node represents a gene and connections between nodes represent a protein-protein or a protein DNA interaction. Of these nodes, 218 were in the 1013-gene set while the remaining 130 were included by virtue of interactions with other nodes. Remaining genes in the set were not involved in any interactions recorded in the physical-interaction database and thus are absent from the network.

Expression data from each genetic and environmental perturbation were integrated with the network to reveal, where known, the particular physical interactions most likely to mediate the observed expression level changes. A physical interaction network was constructed using the set of genes whose mRNA or protein expression levels were significantly altered by at least one pathway perturbation. Each node in the network represents a gene. An arrow directed from one node to another signifies that the protein encoded by the first gene can influence the transcription of the second by DNA binding (protein→DNA interaction) while an undirected line between two nodes signifies that the proteins encoded by each gene can physically interact (protein-protein). Nodes are annotated with a corresponding gene name and, for genes that are members of a gene expression cluster shown in FIG. 2, cluster number. Highly interconnected groups of genes tend to have common biological function and are labeled accordingly.

In FIG. 5a, effects of the gal4Δ +gal perturbation are superimposed on the network, with GAL4 colored red and the grayscale intensity and size of other nodes representing changes in mRNA expression as in FIG. 2 (gene clusters). Physical interactions between two genes whose mRNA-expression levels are both significantly altered appear in bold and are otherwise dotted. Regions of the network corresponding to galactose utilization (FIG. 5b) and glycogen metabolism (FIG. 5c) are shown in greater detail on the right-hand side of the figure. FIG. 5d highlights effects of the wt+gal perturbation (with respect to wt−gal) on the physical network shown for the region corresponding to amino-acid/nucleotide synthesis. Nodes representing genes for which protein data are available contain an additional, inner circle representing the change in protein expression. Each perturbation produces a distinct pattern of highlighted nodes on a common underlying network topology.

The known galactose pathway interactions are present in the physical interaction network (FIG. 5b) and clearly show that a gal4 deletion affects other GAL genes through direct, protein→DNA interactions. The network also highlights numerous protein→DNA interactions that may be responsible for the expression changes observed in other pathways. For instance, expression level changes among the amino acid biosynthesis genes may be in part due to GCN4 (see FIG. 5d), changes in several gluconeogenic genes are controlled by SIP4, and a class of mating genes is under both positive and negative control of MCM1.

Groups of genes whose proteins physically interact often display joint increases or decreases in expression level across the 20 perturbations. In some cases this co-regulation was previously known: for instance, the ribosomal subunits shown in the physical interaction network are simultaneously up- or down-regulated in ten perturbations (with no change in the remaining perturbations), as are genes whose proteins comprise the peroxisomal import complex (PEX5, 13, 14 and 17, co-regulated in eight perturbations) and several complexes involved in amino acid synthesis (e.g. SER3-SER33, as seen in FIG. 5d and six additional perturbations). Examples of inverse regulation are also abundant among interacting proteins. Although in many cases this behavior has not been previously reported, often one protein is a known repressor of the other. For example, as shown in FIG. 5c, the gal4 +gal perturbation leads to an increase in expression of GSY2, which encodes glycogen synthase, and a corresponding decrease in expression of the GSY2-interacting protein PCL10, which encodes a protein kinase. Consistent co- or inverse-regulation over many perturbations provides strong evidence that the corresponding protein-protein interaction occurs in vivo, and is not an artifact of the particular biological assay used (e.g. a two-hybrid screen).

In summary, a physical interaction map of the proteins and genes involved in galactose utilization was prepared by identifying protein and DNA interactions using public data bases, restricting the set of mapped genes to contain only genes that displayed altered expression levels in response to pathway perturbation and genes reported to interact with at least two pathway components, and generating a graphical representation of the network of interacting genes. The Example shows that a physical interaction map can be used to determine and predict the function of genes in the biochemical network.

### EXAMPLE IV

### Model Refinement Using the Predicted and Measured Cellular Response

This example shows that a physical interaction map can be used to determine predict gene function and that the physical interaction map can be refined by further perturbations of network components.

The current model of galactose utilization, as determined by classical genetic and biochemical approaches, predicts many of the specific changes in GAL-gene expression shown in FIGS. 2 and 4. For example, growth of wild type cells in the presence versus absence of galactose strongly induces the galactose utilization enzymes GAL1, 7, and 10 in both mRNA and protein expression level, and GAL2, 3, and 80 are also induced but to a lesser extent. In +gal but not in −gal, deletions of the regulatory genes GAL3 and GAL4 cause a strong decrease in expression of the enzymes. In −gal, the gal80 deletion causes derepression of the GAL enzymes and a corresponding, dramatic increase in their expression; in +gal, this deletion has little or no effect on GAL enzyme expression because these genes are already highly expressed.

Another result not predicted by the current GAL model is that in galactose, gal7Δ and gal10Δ deletions strongly affect the expression levels of other enzymatic genes (see FIG. 2). This effect was reproduced using a different, independently derived gal10Δ strain, although the magnitudes of the observed changes were less pronounced in this case (3-fold vs. ˜30-fold in the original strain). This effect is also supported by evidence that enzyme activities of GAL2 and GAL7 decrease in a gallo mutant. Since the metabolite galactose-l-phosphate (Gal-l-P) accumulates in cells lacking functional GAL7or GAL10, since this metabolite is detrimental in large quantities and since both gal Δ and gal10 deletion strains exhibit markedly slow growth in galactose (as reported in FIG. 2), the observed expression-level changes could be related to buildup of Gal-l-P. The cell may limit Gal-l-P accumulation in these conditions by first sensing toxic levels through an unknown mechanism, then triggering a decrease in GAL enzyme expression.

New model hypotheses were tested systematically through additional genetic or environmental perturbation experiments. In order to test the hypothesis that Gal-l-P mediates the effect of gal7Δ or gal10Δ on the enzymatic genes, a yeast-genome microarray was used to measure mRNA-expression levels of a gal1/gal10 double deletion undergoing steady-state growth in +gal (relative to wt+gal). In this strain, the absence of GAL1 activity was predicted to prevent buildup of Gal-l-P regardless of the function of downstream enzymes such as GAL10. It was hypothesized that if the observed changes in gene expression are mediated by direct sensing of Gal-l-P, they should not occur in the double deletion strain. Enzymatic gene expression was not significantly affected in this perturbation, and the gal1 gal10 expression profile over all affected genes was more similar to the gal1 +gal profile than to the gal10 +gal profile. This model was tested using two new environmental perturbations, in which 2% galactose was added to gal7Δ and gal10Δ cultures undergoing steady-state growth in −gal, cells were harvested after 20 minutes of growth in galactose, and in each case the yeast genome microarray was used to measure mRNA-expression levels relative to wt+gal. Because the GAL enzymes are fully expressed within 20 minutes but Gal-l-P has probably not accumulated in harmful amounts, neither a gal7Δ nor a gal10Δ deletion was predicted to affect expression of other GAL enzymes. The observed expression profiles were consistent with this prediction and further support the refined model.

Several genes involved in these processes show a greater diffference in mRNA expression change compared to protein expression change (see FIG. 4). This indicates that post-transcriptional regulation can play an important role in the metabolic switch. Most strikingly, many ribosomal genes and genes involved in ribosomal synthesis increase by 3- to 5-fold in mRNA expression levels but not in protein expression levels in response to galactose addition. This imbalance can be explained by the high energetic cost of ribosomal assembly, rapid degradation of the ribosomal subunits, or an extremely long time interval between ribosomal-subunit mRNA and protein synthesis (longer than 12-16 hours of overnight growth prior to harvest).

Finally, these studies indicate that Gal4p can regulate several metabolic processes through direct, protein-DNA interactions that are currently absent from the physical interaction network. To identify putative interactions, the well-characterized Gal4p-binding site upstream of genes in several clusters was examined. Clusters 1 and 2 were examined because they contain the GAL enzymes and other known GAL4-regulated genes, clusters 15 and 16 because their profiles are inversely correlated with those of clusters 1 and 2, and clusters 11 and 12 because they display a dramatic decrease in expression in both gal4 +gal and gal4 −gal perturbations (see FIG. 2). A nucleotide weight matrix model of the binding site (TRANSFAC site matrix M00049) was used to identify potential binding sites in the promoter regions of genes in the 997-gene set. Nucleotide sequences of up to 800 bp upstream of translation start sites, terminating at the nearest upstream ORFs, are scored against the weight matrix using MatInspector (Quandt et al., Nucleic Acids Res., 23:4878-4884, (1995)). Parameters (core similarity 0.7, matrix similarity 0.8) arc chosen to predict known Gal4p-regulated genes (eight out of nine) but to return only a moderate number (41) of candidates overall.

Twenty-two out of 270 genes in these candidate clusters had predicted Gal4p-binding sites as listed in Table 1, a significantly greater proportion-than were found in the remaining clusters (p<1.2×10⁻⁴). Among these, binding sites were predicted upstream of YMR318C (cluster 2) and YJL 045W (cluster 15), two genes of unknown function shown in FIG. 3 to have strong mRNA and protein responses to galactose induction. Several genes involved in glycogen accumulation, gluconeogenesis, and respiration also contained Gal4-binding sites, for example PCL10 (cluster 1), YLR164W (cluster 16), and ICL1 (cluster 16). Interestingly, PCL10 was previously implicated by the physical-interaction networks as repressing a key enzyme of glycogen synthesis in several perturbations. Since PCL10 also falls into the same cluster as do the GAL enzymes, these multiple lines of evidence suggest that when galactose is available, Gal4 can directly suppress glycogen synthesis through activation of this repressor. Several genes in these metabolic pathways are likely to be controlled directly by GAL4, by virtue of their characteristic responses to perturbation and by the presence of Gal4p-binding sites in their promoter sequences. Each gene with a predicted Gal4-p binding site identifies a protein-DNA interaction that could be added to the physical-interaction network for verification through subsequent perturbations. In this manner, a physical interaction map can be refined to more completely define the interactions among network components that affect cellular functions, such as galactose utilization. Other genes have been implicated by the physical-interaction networks to be involved in a variety of cellular functions, as shown in Table 2. Physical interaction maps can be refined as described above to confirm hypotheses regarding cellular functions of these genes, using a variety of cellular systems, such as the yeast strains described in Table 2.

TABLE 1
Gal4p binding-site predictions

| | | | | | |
|---|---|---|---|---|---|
| | | Upstream | Core | Matrix | |
| | | position | similarity | similarity | |
| Cluster | Gene | (+/−strand) | score | score | Sequence |

| | | | | | |
|---|---|---|---|---|---|
| 1 | GAL1 | 456 (+) | 1.000 | 0.840 | GTACGGATTAGAAGCCGCCGAGC |
| 1 | GAL1 | 437 (+) | 1.000 | 0.880 | GAGCGGGCGACAGCCCTCCGACG |
| 1 | GAL1 | 419 (+) | 0.875 | 0.920 | CGACGGAAGACTCTCCTCCGTGC |
| 1 | GAL1 | 355 (+) | 1.000 | 0.860 | CCTCGCGCCGCACTGCTCCGAAC |
| 1 | GAL10 | 336 (−) | 1.000 | 0.860 | CCTCGCGCCGCACTGCTCCGAAC |
| 1 | GAL10 | 272 (−) | 0.875 | 0.920 | CGACGGAAGACTCTCCTCCGTGC |
| 1 | GAL10 | 254 (−) | 1.000 | 0.880 | GAGCGGGCGACAGCCCTCCGACG |
| 1 | GAL10 | 235 (−) | 1.000 | 0.840 | GTACGGATTAGAAGCCGCCGAGC |
| 1 | GAL7 | 282 (−) | 1.000 | 0.870 | CTTCGCTCAACAGTGCTCCGAAG |
| 1 | GAL7 | 195 (−) | 1.000 | 0.924 | TCACGGTCAACAGTTGTCCGAGC |
| 1 | GAL7 | 188 (+) | 1.000 | 0.848 | CAACTGTTGACCGTGATCCGAAG |
| 1 | GCY1 | 372 (−) | 1.000 | 0.828 | CCCCGGAATAGTCTGCCCCGATT |
| 1 | PCL10 | 235 (−) | 1.000 | 0.905 | GATCGGTGCAATATACTCCGAGC |
| 1 | GAL2 | 533 (−) | 1.000 | 0.818 | TTCCGGAAGGAAGCTTTCCGAAT |
| 1 | GAL2 | 419 (+) | 0.875 | 0.903 | CACCGGCGGTCTTTCGTCCGTGC |
| 1 | GAL2 | 400 (−) | 0.800 | 0.825 | GAACGGCGCAGATATCTCCGCAC |
| 1 | GAL2 | 336 (+) | 1.000 | 0.867 | TATCGGGGCGGATCACTCCGAAC |
| 1 | GAL2 | 331 (+) | 1.000 | 0.855 | GGGCGGATCACTCCGAACCGAGA |
| 1 | YEL057C | 417 (−) | 0.875 | 0.811 | CCCCGGACGGCAGCCGCCCGTCC |
| 1 | YGR090W | 381 (−) | 0.875 | 0.819 | CAACGGCATGCAGCGAGCCGTAG |
| 1 | YPL066W | 101 (+) | 1.000 | 0.856 | TCACGGTCATCACTGCTCCGACA |
| 2 | GAL3 | 291 (−) | 1.000 | 0.938 | GTTCGGCACACAGTGGACCGAAC |
| 2 | GAL80 | 175 (+) | 1.000 | 0.952 | TACCGGCGCACTCTCGCCCGAAC |
| 2 | YPR194C | 624 (−) | 1.000 | 0.814 | CGTCGGACAGCAACCCCCCGATT |
| 2 | YMR318C | 239 (+) | 1.000 | 0.830 | GTCCGGTCCGTCCTTGACCGAAG |
| 11 | RPA49 | 249 (+) | 1.000 | 0.804 | GACCGGACACCTAATCACCGACG |
| 11 | YLR201C | 143 (−) | 1.000 | 0.812 | CTTCCGCCTAATATAGTCCGAAA |
| 15 | YJL045W | 524 (−) | 1.000 | 0.804 | CGACGGGGAATTGAACCCCGATC |
| 15 | MBR1 | 313 (+) | 0.800 | 0.811 | GAGCGGCTCCCCTTTCCCCGGAA |
| 15 | MRK1 | 268 (−) | 0.725 | 0.828 | CATCGGACGACTTTGCTCCCAGG |
| 15 | YMR031C | 305 (−) | 1.000 | 0.801 | TTTTGGGTAACAGCGGACCGAAG |
| 16 | ICL1 | 407 (+) | 1.000 | 0.810 | CCCAGGTTTCCATTCATCCGAGC |
| 16 | YLR164W | 243 (+) | 1.000 | 0.836 | GATTGGAGTACCCTTATCCGAAG |
| 16 | YIL057C | 192 (+) | 0.875 | 0.867 | CGGCGGTTGGCAATCGTCCGTAT |

TABLE 2
New observations and hypothesis
†EP = Expression Profile

| | | Possible Systems- |
|---|---|---|
| New Observations | Hypothesis | Level Tests† |
| Slow growth of | [1] These | Examine EP in a |
| gal80Δ strain in | observations of | gal80Δgal4Δ |
| raffinose and | stress caused by | strain, in which |
| associated, | depression of | the GAL enzymes |
| widespread | either the GAL | and the GAL |
| effects on gene | enzymes or the | transporter are |
| expression. | GAL transporter. | not expressed. |
| | [2] The observed | If the EP is |
| | response is | similar to that |
| | independent of | of a wild type |
| | the GAL genes or | strain (and the |
| | GAL transporter. | NEW OBSERVATIONS |
| | | are not |
| | | reproduced in |
| | | this strain), |
| | | choose hypothesis |
| | | [1]. If the EP |
| | | is similar to |
| | | that of gal80Δ, |
| | | choose hypothesis |
| | | [2]. To further |
| | | distinguish |
| | | between and, |
| | | compare these EPs |
| | | to the EP of a |
| | | gal80Δgal2Δ |
| | | strain (GAL2 is |
| | | the transporter). |
| Decrease in mRNA | The Gal-1-P | Examine EPs of a |
| expression of | metabolic | gal7Δgal1Δ and a |
| GAL1, 2, 3, and | intermediate is | gal10Δgal1Δ |
| 80 in a gal7Δ or | known to | strain. Since |
| gal10Δ strain in | accumulate under | GAL1catalyzes the |
| galactose. | these conditions. | formation of Gal- |
| | [1] The observed | 1-P from |
| | expression | galactose, Gal-1- |
| | changes depend on | P levels should |
| | the level of Gal- | decrease |
| | 1-P. | dramatically in |
| | [2] The changes | these strains. |
| | do not depend on | If the expression |
| | Gal-1-P levels. | changes in GAL1, |
| | | 2, 3 and 80 do |
| | | not occur in |
| | | these strains |
| | | (and their EPs |
| | | are more similar |
| | | to the EP of |
| | | gal1Δ than to the |
| | | EPs of gal7Δ or |
| | | gal10Δ), this |
| | | lends support for |
| | | hypothesis [1]. |
| | | Conversely, if |
| | | these EPs are |
| | | similar to those |
| | | of gal7Δ and |
| | | gal10Δ, |
| | | hypothesis [2] is |
| | | better supported. |
| Most ribosomal | [1] Ribosomal | Grow cells to log |
| proteins are | proteins are | phase with and |
| differentially | regulated at the | without |
| expressed in | level of | galactose. For |
| response to | translation. | each culture, |
| galactose, at the | [2] Ribosomal | measure |
| level of mRNA but | proteins are | translation state |
| not protein. | regulated at the | of ribosomal- |
| Thus, ribosomal | level of protein | protein mRNAs |
| proteins appear | degradation. | using yeast- |
| to be post- | | genome |
| transcriptionally | | microarrays, |
| regulated (verify | | according to the |
| by directed | | method of Zong et |
| biochemical | | al. [PNAS 96, |
| assays, e.g. | | 10632 (1999)]. |
| Northwestern/West | | If the two |
| ern blots). | | cultures differ |
| | | in translation |
| | | state, choose |
| | | hypothesis [1]. |
| | | In addition, halt |
| | | translation in |
| | | both cultures |
| | | using |
| | | cyclohexamide, |
| | | then track |
| | | resulting |
| | | abundances of all |
| | | ribosomal |
| | | proteins over |
| | | time using global |
| | | proteomics (i.e. |
| | | the ICAT |
| | | procedure). If |
| | | rate of protein |
| | | decrease differs |
| | | between the two |
| | | cell cultures, |
| | | choose hypothesis |
| | | [2]. |
| Other than the | As above for the | As above for the |
| ribosomal | ribosomal | ribosomal |
| subunits (see | proteins. | proteins. |
| above), several | | |
| additional genes | | |
| respond to | | |
| galactose | | |
| induction in mRNA | | |
| expression or | | |
| protein | | |
| expression, but | | |
| not both. For | | |
| example, see data | | |
| points for ERG10, | | |
| TOK1, OAR1, GUT2, | | |
| and ALD6 in FIG. | | |
| 3. | | |
| The expression | Many of the | |
| levels of genes | initial | |
| in a variety of | perturbations | |
| other metabolic | affect whether | |
| pathways respond | cells can utilize | |
| to perturbations | galactose to | |
| of the GAL | produce energy. | |
| pathway. | Thus, consider | |
| | for each affected | |
| | pathway | |
| | individually: | |
| | [1] The affected | |
| | pathway depends | |
| | on galactose or | |
| | GAL genes | |
| | specifically. | |
| | [2] The affected | |
| | pathway depends | |
| | on the total | |
| | amount of | |
| | available energy, | |
| | independent of | |
| | galactose. | |
| Some proteins | The two-hybrid | |
| predicted to | prediction | |
| interact by a | reflects a | |
| two-hybrid screen | physical | |
| are co- or | association | |
| inversely- | between the | |
| expressed over | proteins in vivo, | |
| many perturbation | and is not an | |
| conditions. | artifact of the | |
| Examples are | two-hybrid | |
| Icl1-Srp1, Gdh2- | screening | |
| Tahl8, and Myo2- | process. | |
| Mlc2. | Verify by IP or | |
| | co-localization | |
| | experiments (e.g. | |
| | FRET) for each | |
| | protein pair. | |
| Contrary to | We have examined | |
| previous evidence | galactose- | |
| (Oh and Hopper | induction in the | |
| 1990; Zheng | presence of | |
| 1997), mRNA | raffinose, while | |
| expression levels | these previous | |
| of GAL5 and GAL6 | studies have | |
| do not change in | examined | |
| response to | galactose- | |
| galactose, nor | induction in the | |
| does GAL6 affect | presence of other | |
| the expression | substrates such | |
| levels of any | as glycerol. | |
| other GAL genes | Also, our strains | |
| when deleted. | differ in genetic | |
| | background from | |
| | those in the | |
| | previous studies. | |
| | [1] GAL5 and GAL6 | |
| | expression levels | |
| | depend on | |
| | raffinose and/or | |
| | glycerol. | |
| | [2] GAL5 and GAL6 | |
| | exhibit strain- | |
| | to-strain | |
| | differences in | |
| | expression. | |
| Approximately 15 | Gal4p regulates | |
| genes with | these genes | |
| predicted Gal4p- | directly, through | |
| binding sites | DNA-binding of | |
| also had EPs that | their promoter | |
| were strongly | regions. Since | |
| correlated (or | several of these | |
| anti-correlated) | genes play | |
| with those of the | important roles | |
| known GAL genes. | in metabolic | |
| | pathways such as | |
| | glycogen | |
| | accumulation and | |
| | gluconeogenesis, | |
| | the galactose | |
| | regulatory | |
| | mechanism (i.e. | |
| | consisting of | |
| | Gal3p, Gal80p, | |
| | and Gal4p) | |
| | control these | |
| | other pathways | |
| | under certain | |
| | conditions. | |
| | Verify by | |
| | directed | |
| | biochemical | |
| | experiments such | |
| | as chromatin | |
| | immuno- | |
| | precipitation, | |
| | etc. | |

Throughout this application various publications have been referenced within parentheses. The disclosures of these publications in their entireties are hereby incorporated by reference in this application in order to more fully describe the state of the art to which this invention pertains.

Although the invention has been described with reference to the disclosed embodiments, those skilled in the art will readily appreciate that the specific experiments detailed are only illustrative of the invention. It should be understood that various modifications can be made without departing from the spirit of the invention. Accordingly, the invention is limited only by the following claims.

What is claimed is:

1. A method of predicting a behavior of a biochemical system, comprising:
(a) comparing two or more data integration maps of a biochemical system obtained under different conditions, said data integration map comprising at least two networks, and
(b) identifying correlative changes in at least two value sets between said two or more data integration maps with said different conditions, wherein said correlative changes predict a behavior of said biochemical system.

2. The method of claim 1, wherein said biochemical system is selected from the group consisting of a cell, tissue and organism, or a constituent system thereof.

3. The method of claim 1, wherein said value sets further comprise at least two or more data elements.

4. The method of claim 1, wherein said value sets further comprise at least one value set having three or more data elements.

5. The method of claim 1, wherein said value sets further comprise a data element corresponding to a physical interaction.

6. The method of claim 1, wherein said at least two or more networks further comprise three or more networks.

7. The method of claim 1, wherein said two or more data integration maps further comprise a data integration map having two or more perturbed conditions.

8. The method of claim 1, wherein said two or more data integration maps further comprise a data integration map having perturbed conditions for substantially all components within at least one of said networks.

9. The method of claim 1, wherein said correlative changes in at least two value sets between said two or more data integration maps further comprise value sets within the same network.

10. The method of claim 1, wherein said correlative changes in at least two value sets between said two or more data integration maps further comprise value sets within different networks.

11. The method of claim 1, wherein said correlative changes in at least two value sets between said two or more data integration maps further comprise changes in three or more value sets.

12. The method of claim 1, wherein said correlative changes in at least two value sets between said two or more data integration maps further comprise jointly coordinated or inversely coordinated changes in data elements.

13. The method of claim 1, wherein said correlative changes in at least two value sets between said two or more data integration maps further comprise data elements selected from the group consisting of nucleic acid expression, protein expression, polypeptide-polypeptide interaction, nucleic acid-polypeptide interaction, metabolite abundance, and growth rate.

14. The method of claim 1, wherein said at least two networks further comprise at least five components for each of said networks.

15. The method of claim 1, wherein said behavior is selected from the group consisting of cellular phenotype, biochemical activity, expression level and accumulation level.

16. A method of predicting a behavior of a biochemical system, comprising:
(a) obtaining a first data integration map of a biochemical system, said data integration map comprising value sets of two or more data elements for at least two networks;
(b) producing a second data integration map of said biochemical system under a perturbed condition, said second data integration map comprising said value sets of two or more data elements for said at least two networks, and
(c) identifying correlative changes in at least two value sets in said second data integration map with said perturbed condition, wherein said correlative changes predict a behavior of said biochemical system.

17. The method of claim 16, wherein said biochemical system is selected from the group consisting of a cell, tissue and organism, or a constituent system thereof.

18. The method of claim 16, further comprising at least one value set having three or more data elements.

19. The method of claim 16, wherein said value sets of two or more data elements further comprise three or more data elements.

20. The method of claim 16, wherein one of said data elements is a physical interaction.

21. The method of claim 16, wherein said at least two or more networks further comprise three or more networks.

22. The method of claim 16, wherein said second data integration map further comprises two or more perturbed conditions.

23. The method of claim 16, wherein said second data integration map further comprises perturbed conditions for substantially all components within at least one of said networks.

24. The method of claim 16, wherein said correlative changes in at least two value sets within said second data integration map further comprise value sets within the same network.

25. The method of claim 16, wherein said correlative changes in at least two value sets within said second data integration map further comprise value sets within different networks.

26. The method of claim 16, wherein said correlative changes in at least two value sets within said second data integration map further comprise changes in three or more value sets.

27. The method of claim 16, wherein said correlative changes in at least two value sets within said second data integration map further comprise jointly coordinated or inversely coordinated changes in data elements.

28. The method of claim 16, wherein said correlative changes in at least two value sets within said second data integration map further comprise data elements selected from the group consisting of nucleic acid expression, protein expression, polypeptide-polypeptide interaction, nucleic acid-polypeptide interaction, metabolite abundance, and growth rate.

29. The method of claim 16, wherein said at least two networks further comprise at least five components for each of said networks.

30. The method of claim 16, further comprising repeating steps (b) and (c) at least once.

31. The method of claim 16, wherein said behavior is selected from the group consisting of cellular phenotype, biochemical activity, expression level and accumulation level.

32. A method of predicting a behavior of a biochemical system, comprising:
(a) obtaining a first physical interaction map of a biochemical system, said physical interaction map comprising value sets of a physical interaction data element and an expression data element for at least two independent networks;
(b) producing a second physical interaction map of said biochemical system under a perturbed condition, said second physical interaction map comprising said value sets of a physical interaction data element and an expression data element for at least two independent networks, and
(c) identifying correlative changes in at least two value sets in different independent networks in said second physical interaction map with said perturbed condition, wherein said correlative changes predict a behavior of said biochemical system.

33. The method of claim 32, wherein said biochemical system is selected from the group consisting of a cell, tissue and organism, or a constituent system thereof.

34. The method of claim 32, wherein said expression data element further comprises a nucleic acid expression data element and a polypeptide expression data element.

35. The method of claim 32, wherein said at least two or more independent networks further comprise three or more independent networks.

36. The method of claim 32, wherein said second physical interaction map further comprises two or more perturbed conditions.

37. The method of claim 32, wherein said second physical interaction map further comprises perturbed conditions for substantially all components within at least one of said independent networks.

38. The method of claim 32, wherein said correlative changes in at least two value sets in different independent networks in said second physical interaction map further comprise changes in three or more value sets.

39. The method of claim 32, wherein said correlative changes in at least two value sets in different independent networks in said second physical interaction map further comprise jointly coordinated or inversely coordinated changes in said data elements.

40. The method of claim 32, wherein said correlative changes in at least two value sets in different independent networks in said second physical interaction map further comprise data elements selected from the group consisting of nucleic acid expression, protein expression, polypeptide-polypeptide interaction, nucleic acid-polypeptide interaction, metabolite abundance, and growth rate.

41. The method of claim 32, wherein said at least two independent networks further comprise at least five components for each of said independent networks.

42. The method of claim 32, further comprising repeating steps (b) and (c) at least once.

43. The method of claim 32, wherein said behavior is selected from the group consisting of cellular phenotype, biochemical activity, expression level and accumulation level.

44. A method of identifying functionally interactive components of a biochemical system, comprising:
(a) obtaining a set of components within a biochemical system linked by physical interactions;
(b) obtaining a set of components within a biochemical system linked by expression or activity, and
(c) integrating the set of physically linked components with the set of components linked by expression or activity to produce a network of common components functionally interactive within the system, each component within said network of common components being characterized as having at least one physical interaction with a component within said set of components linked by expression or activity.

45. The method of claim 44, wherein said physical interactions further comprise polypeptide-polypeptide interactions, polypeptide-nucleic acid interactions and nucleic acid-nucleic acid interactions.

46. The method of claim 44, wherein said expression further comprises transcription or translation.

47. The method of claim 44, wherein said network further comprises two or more pathways.

48. The method of claim 44, wherein said network further comprises a biochemical pathway, a gene expression pathway and a regulatory pathway.

49. A method of identifying a component of a biochemical network, comprising:
(a) preparing a physical interaction map between two or more system components;
(b) identifying a system component exhibiting altered expression or activity in response to perturbation of a pathway component, and
(c) refining the physical interaction map to include a pathway component, an altered system component and an unaltered system component exhibiting at least one physical interaction with an altered system component, said refinement identifying at least one component of an biochemical interaction network by inclusion into said physical interaction map.

50. The method of claim 49, wherein said component further comprises nucleic acid or polypeptide.

51. The method of claim 49, wherein said biochemical network further comprises two or more pathways.

52. The method of claim 49, wherein said biochemical network further comprises a biochemical pathway, a gene expression pathway, and a regulatory pathway.

53. The method of claim 49, wherein said physical interaction map further comprises polypeptide-polypeptide interactions, polypeptide-nucleic acid interactions and nucleic acid-nucleic acid interactions.

54. The method of claim 49, further comprising perturbing two or more pathway components.

55. The method of claim 49, further comprising perturbing five or more pathway components.

56. The method of claim 49, wherein said altered expression further comprises altered transcription or translation.

57. A method of identifying a component of a biochemical network, comprising:
(a) perturbing the expression or activity of at least one pathway component;
(b) measuring a response of one or more pathway components;
(c) determining physical interactions between one or more system components and said one or more pathway components to identify candidate network components, and
(d) determining a change in expression or activity of a candidate network component affected by the perturbation of at least one pathway component, wherein a candidate network component exhibiting a change in expression or activity is identified as a component of the biochemical network.

58. The method of claim 57, wherein said component further comprises nucleic acid or polypeptide.

59. The method of claim 57, wherein said biochemical network further comprises two or more pathways.

60. The method of claim 57, wherein said biochemical net work further comprises a biochemical pathway , a gene expression pathway, and a regulatory pathway.

61. The method of claim 57, further comprising perturbing two or more pathway components.

62. The method of claim 57, further comprising perturbing five or more pathway components.

63. The method of claim 57, wherein said change in expression further comprises a change in transcription or translation of said candidate network component.

64. A method of screening for compounds that restore a perturbation state of a biochemical system, comprising:
(a) obtaining a data integration map of a perturbed biochemical system, said data integration map comprising at least two networks;
(b) contacting a biochemical system exhibiting a perturbation state corresponding to said data integration map with a test compound, and
(c) producing a second data integration map of said biochemical system contacted with said test compound, a compound that restores perturbed states in at least two value sets of said data integration map to unperturbed states indicating that said compound has biochemical system restoring activity.

65. The method of claim 64, wherein said biochemical system is selected from the group consisting of a cell, tissue and organism, or a constituent system thereof.

66. The method of claim 64, wherein said data integration map of a perturbed biochemical system, further comprises two or more perturbed conditions.

67. The method of claim 64, wherein said at least two or more networks further comprise three or more networks.

68. A method of diagnosing or prognosing a pathological condition, comprising:
(a) comparing a data integration map of a biochemical system for an individual suspected of having a pathological condition to one or more data integration maps of said biochemical system produced from an individual exhibiting a known condition, said data integration maps comprising at least two networks, and
(b) identifying a data integration map representing said know condition that is substantially the same as said data integration map for said individual suspected of having a pathological condition, said identified data integration map indicating the presence or absence of a pathological condition.

69. The method of claim 68, wherein said biochemical system further comprises a cell, a tissue, or a constituent system thereof.

70. The method of claim 68, wherein said data integration map of said biochemical system, further comprises two or more perturbed conditions.

71. The method of claim 68, wherein said at least two or more networks further comprise three or more networks.

72. The method of claim 68, wherein said known condition further comprises a normal or pathological condition.

73. The method of claim 68, wherein said known condition further comprises one or more prognostic conditions.

74. The method of claim 68, wherein said known condition further comprises one or more predisposition conditions.
